(19) United States
(12) Patent Application Publication
(10) Pub. No.: US 2005/0187855 A1
(43) Pub. Date: Aug. 25, 2005

(54) Method for analyzing trade data

(76) Inventors: David P. Brennan, Hinsdale, IL (US); William R. Weldon, Hinsdale, IL (US); Mark D. Thorne, Clarendon Hills, IL (US)

Correspondence Address: BEEM PATENT LAW FIRM, 53 W. JACKSON BLVD., SUITE 1352, CHICAGO, IL, 60604-3787, US

(21) Appl. No.: 10/784,007

(22) Filed: Feb. 20, 2004

(51) Int. Cl. G06F 17/60

(52) U.S. Cl. 705/37

(57) ABSTRACT

A method for analyzing trade data for financial products comprising the steps of selecting at least one financial product from a plurality of financial products; selecting a first time span, wherein the first time span includes a plurality of time units; determining trade data for the first time span for the at least one financial product; displaying the trade data according to the plurality of time units; selecting at least one of the plurality of time units; determining a second time span, wherein the second time span includes at least the selected at least one time unit; determining prices and volumes for the at least one financial product for the second time span; classifying the prices according to a plurality of price zones; and displaying the plurality of price zones and corresponding volumes for the plurality of price zones.

### BACKGROUND OF THE INVENTION

1. Field of the Invention

The present invention relates to information retrieval and analysis systems, and more particularly to systems designed for gathering, organizing, and analyzing trading information related to financial markets and financial products, and still more particularly for analyzing trade data related to the price and trade volume of commodities and over the counter financial products.

2. Description of the Related Art

Financial institutions have made trade information available for financial products traded at or through those institutions. Examples of financial institutions and information services that may be provided can be found in Bloomberg's July 2003 listing of financial data services, which is incorporated herein by reference.

Commodity and stock information analysis software typically permits one to retrieve historical trade information for a particular financial product, e.g., a stock, commodity, or futures contract, and graph or tabulate various data over time. For example, U.S. Pat. No. 6,510,419 teaches a method for graphing analysts' earning estimates for a financial product over time. U.S. Pat. No. 5,414,838 teaches a method for retrieving historical market information for a financial product based on a database query.

Prior art analysis software has been directed toward analyzing trade information from a single perspective. For example, the Technical Analysis application by Yahoo Finance permits one to plot trading data for a financial product, e.g., stock price or trade volume, against time. Another example is the OptionVue5 application by OptionVue Systems which permits one to plot and tabulate trade data for options and search for financial products that meet user-specified performance criteria.

A shortfall of the prior art analysis software has been the inability to analyze trade data from multiple perspectives quickly, simultaneously, and dynamically. Information about price versus volume may be lost when analyzing price versus time, and some desirable charts and graphs may be time consuming and difficult, if not impossible, to prepare with existing applications. Financial exchanges, e.g., the Chicago Board of Trade, currently may release 20,000 to 30,000 lines of data daily, and as they begin reporting more detailed financial data, the number may increase to 500,000 or more lines of data daily. These data may be raw lists of numbers, e.g., reflecting individual trades, which may contain little or no useful, analytical information for the trader. The prior art may not permit the user to extract much of the useful information that exists in these data. Until now, there has been no adequate way to analyze price, statistical trade measures, and other trade data against volume and against time, both simultaneously and dynamically, according to the user's preferences.

### BRIEF DESCRIPTION OF THE DRAWINGS

FIG. 1 is a screenshot a computer application implementing the invention having a time unit table and price zone table.

FIG. 2 is a flow chart of a method of selecting, determining, and displaying trade data for a time unit panel.

FIG. 3 is a screenshot of a time selection panel.

FIGS. 4A and 4B are a flow chart of a method of implementing an interactive price zone panel and time unit panel.

FIG. 5 is a screen shot of a computer application implementing the invention having a time unit graph and a price zone table.

FIGS. 6A and 6B are a listing of financial products.

FIG. 7 is a screenshot of an options selection panel for futures contracts.

FIG. 8 is a screenshot of an options selection panel for options contracts.

FIG. 9 is an example schematic of row layout in a time unit table of trade data.

FIG. 10 is a listing of columns for a table of trade data.

FIG. 11 is a screenshot of a graph of price data by time unit.

FIG. 12 is a screenshot of a computer implementation of the invention having a time unit table and a price zone graph.

FIG. 13 is a listing of formulas for statistical calculations.

FIG. 14 is a flow chart of a trade data refresh method.

FIG. 15A is an example of a raw data file, specifically a liquidity data bank file.

FIG. 15B is an example of a raw data file, specifically an option price data file.

FIG. 15C is an example of a raw data file, specifically an end of day prices file.

FIG. 15D is an example of a raw data file, specifically an option open interest file.

FIG. 16 is a screenshot of a trade data update processing application.

FIG. 17 is another screenshot of a trade data update processing application.

FIG. 18 is an overview of an example computer and server configuration for implementing the invention.

FIG. 19 is flow chart for a method of determining volume event groups.

FIG. 20 is a flow chart of a computer implementation of the invention.

FIG. 21 is a screenshot of a volume event graph.

FIG. 22A is an example of trade data which may be used to determine volume event groups.

FIG. 22B is an example of volume event groups that may be determined from trade data in FIG. 22B with a volume event trigger of 30,000.

### BRIEF SUMMARY OF THE INVENTION

A method for analyzing trade data for financial products comprising the steps of selecting at least one financial product from a plurality of financial products; selecting a first time span, which includes a plurality of time units; determining trade data for the financial product and first time span; displaying the trade data classified according to the plurality of time units; selecting at least one of the time units; determining a second time span that includes at least the selected time unit; determining prices and volumes for the financial product and the second time span; classifying the prices into a plurality of price zones; and displaying the price zones and corresponding volumes for the price zones.

Each of the prices zones may be a discrete price. In addition, the financial product may be a futures or options contract. The method may further comprise selecting at least one price zone from the price zones, displaying a graph of prices versus time, and drawing a price line on the graph corresponding to the selected price zone. The step of displaying corresponding volumes for the price zones may further comprise determining volumes over the second time span. Determining the second time span may further comprise the steps of selecting a time unit count, so the second time span may include the selected time unit and a number of time units, equal to the time unit count, before the selected time unit. Displaying the trade data may further comprise displaying for each one of the time units at least one volume corresponding to at least one of a plurality of trader groups. Displaying the price zones may further comprise displaying, for each one of the price zones, at least one volume corresponding to at least one trader group. Furthermore, displaying trade data may further comprise displaying a composite implied volatility, a modified composite implied volatility, an in-the-money pain strike price, an out-of-the-money pain strike price, an in-the-money pain open interest, out-of-the-money paint open interest.

In another aspect of the invention, the method for analyzing trade data for financial products includes the following steps. At least one financial product, a first time span, and a time unit size may be selected. The first time span may be divided into time units. Trade data may be determined for the financial product. The trade data may include contract prices, classifying the trade data into time units. A subspan of the first time span may be selected, and a second time span may be determined that includes at least the selected subspan of the first time span. Trade data that includes contract prices may be determined for the second time span for the financial product. The trade data for the second time span may be classified into price zones. At least one of the price zones may be selected. A subset of the trade data for the first time span that has contract prices that fall within the selected price zone may be identified.

In yet another aspect of the invention, the method for analyzing trade data for financial products includes the following step. At least one financial product, time span, and volume event trigger may be selected. Trade data may be determined. The trade data may include contract prices, volumes, and trade times for the financial product. The trade data may be classified according to volume event groups. The volume event groups may include trade data having an accumulated volume corresponding to the volume event trigger. A low price, high price, open price, and close price for each volume event group may be determined. The method may further include displaying a graph of the volume event groups by trade times.

In yet another aspect of the invention, trade data for financial product contracts may be organized. Organizing the trade data may include the following steps. The data may be processed. These data may include volumes, prices, strike prices, option open interests, contract terms, and trade dates. The volumes may be classified according to the prices and the trade dates. The strike prices may be classified according to the contract terms and the trade dates. The option open interests may be classified according to the contract terms, the trade dates, and the strike prices. The processing of trade data may further include processing end of day prices, and the end of day prices may be classified according to the contract terms and the trade dates.

### DETAILED DESCRIPTION OF THE INVENTION

1. Overview

1.1 Displays

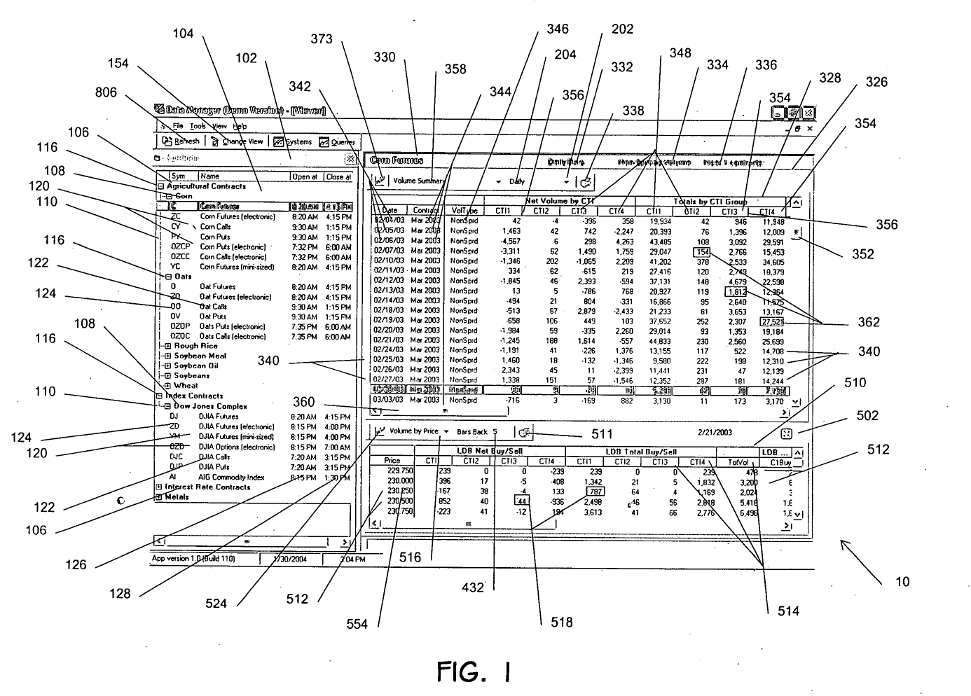

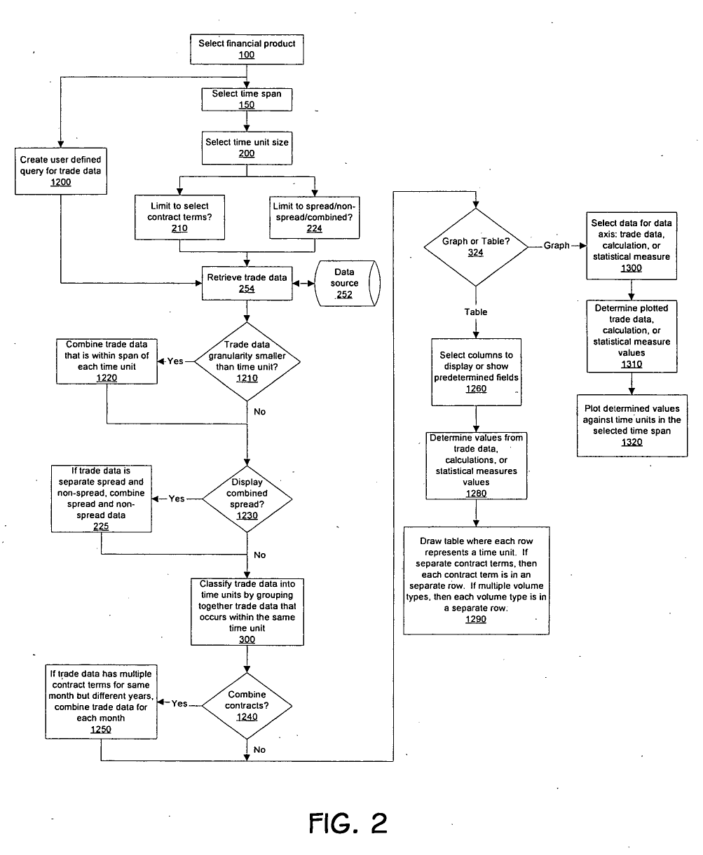

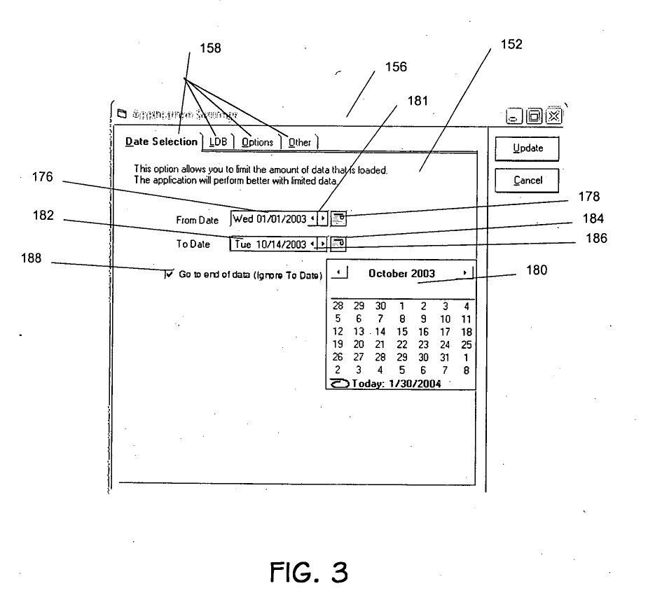

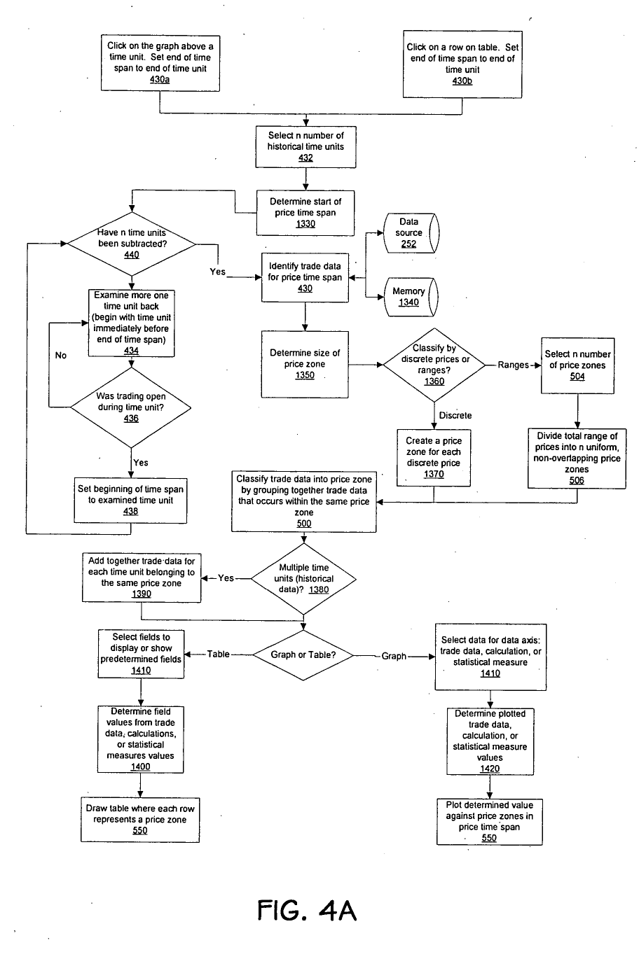

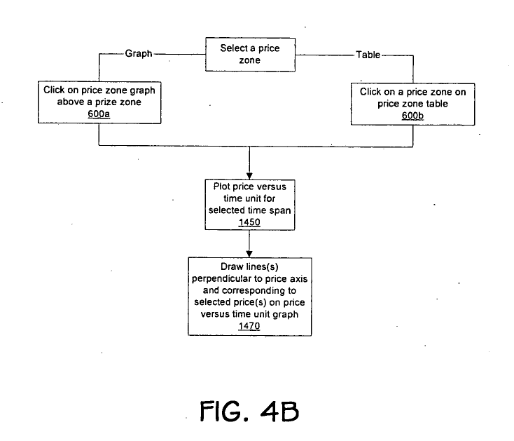

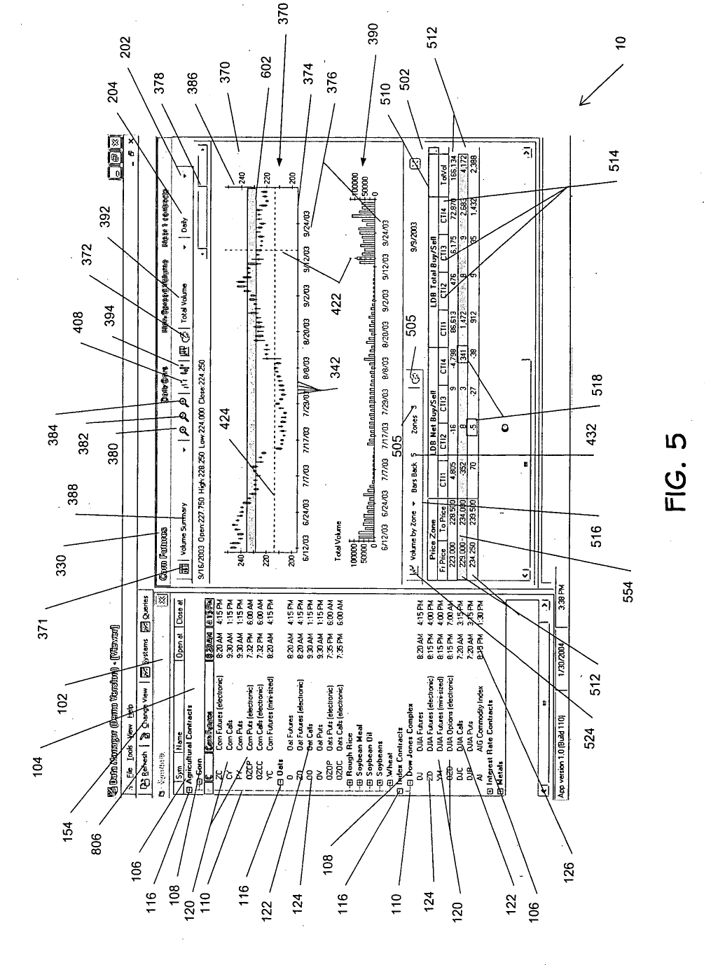

The method permits the user to extract useful information from financial data in a local, network, or web-based application, such as a MICROSOFT WINDOWS application 10 (FIG. 1), on a computer, such as a personal computer 20 shown in FIG. 18. Now turning to FIG. 2, the user may select a financial product (step 100, FIG. 2) using a financial product selection panel 102 (FIG. 1). The user then may select a time span (step 150, FIG. 2) using a time span panel tab 152 (FIG. 3). Optionally, the user may select a time unit size (step 200, FIG. 2) using a time unit size field. Alternatively, application 10 may select a time unit size for the user or default to a predetermined time unit size. Application 10 then may retrieve trade data (step 250, FIG. 2) for the selected time span and classify the trade data into time units (step 300, FIG. 2). Application then 10 may display the trade data (step 324, FIG. 2) in a time unit panel 326 (FIG. 1) as a time unit table 328 (FIG. 1) or a time unit graph 370 (FIG. 5). The user may select a time unit (steps 430a-b, FIG. 4A) from the time unit table 326 (FIG. 1) or time unit graph 370 (FIG. 5). Application 10 then may determine a second time span (step 1330, FIG. 4A) which includes the selected time unit. Application 10 may determine trade data for the second time span (step 430, FIG. 4A). The trade data may be classified into price zones (step 500, FIG. 4A). Application 10 then may display price zones 554 and corresponding volumes for the price zones 554 (FIG. 1).

1.2 Interaction

In addition, application 10 may permit the user to select a price zone (step 600a-b, FIG. 4B). Application 10 then may draw price lines 602 (FIG. 5) on the time unit graph 370. The price lines 602 may have substantial width to appear as a bar, such as when the selected price zone comprises multiple prices. These graphs, tables, and method of user interaction may allow the user to analyze trade data by a novel method which may permit the user to determine useful information from the trade data which was inaccessible before.

2. Selection of a Financial Product

2.1 Content of Financial Product Selection Panel

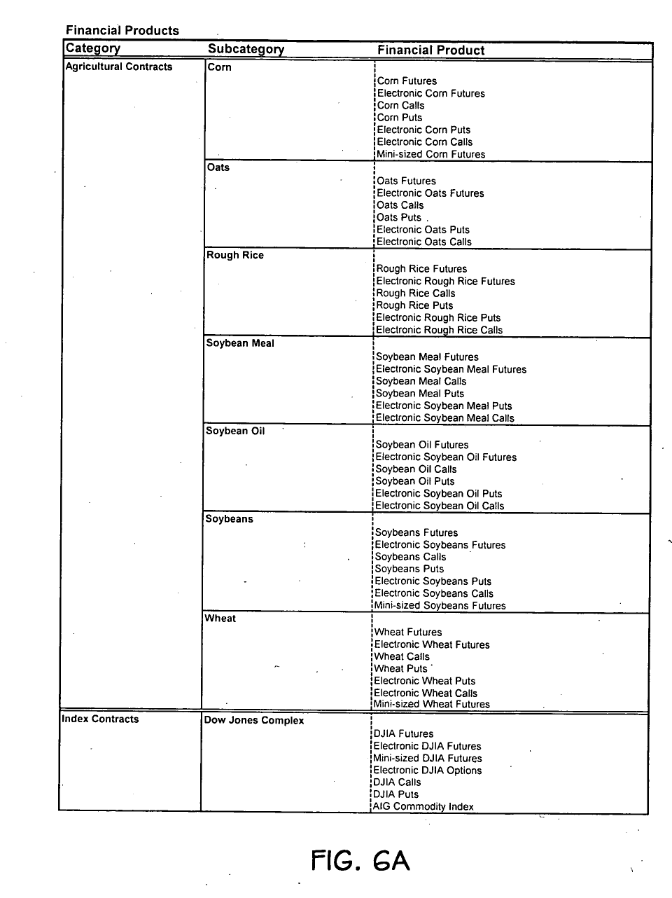

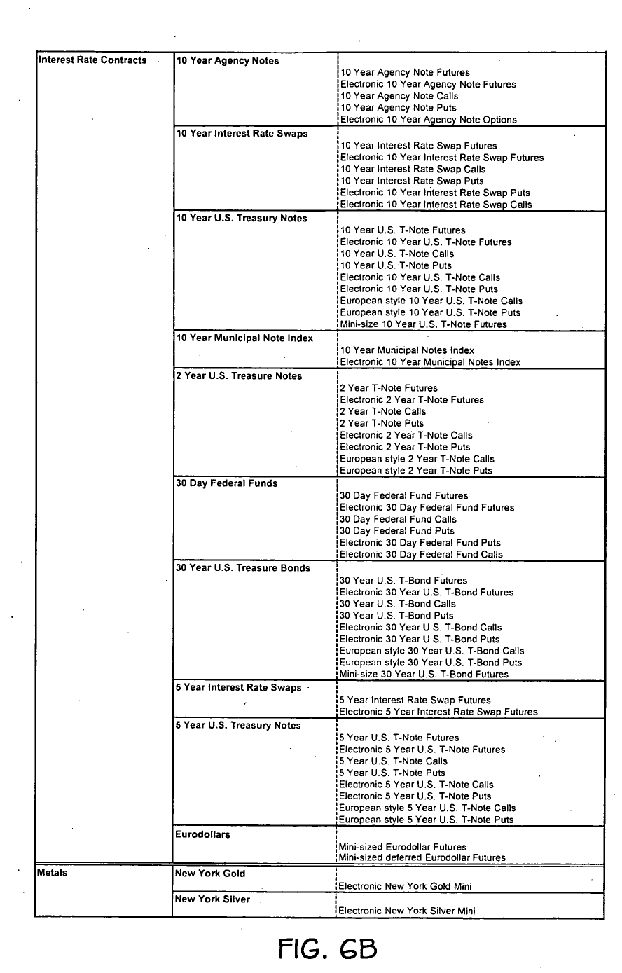

Financial product selection panel 102 (FIG. 1) typically comprises a listing of financial products 104. Listing of financial products 104 may be derived from a predetermined list included with application 10, a list obtained from a financial data provider or data source, a list of financial products traded at or through a financial exchange or institution, or a list entered by the user. Listing of financial products 104 may be classified into categories 106 and one or more layers of subcategories 108. FIGS. 6A and 6B provide an example listing of the categories, subcategories, and financial products that currently may be traded at a specific financial institution, viz., the Chicago Board of Trade. Alternatively, listing of financial products 104 may comprise financial products traded at any financial institution.

As there are many financial institutions which may currently produce trade data and many that in the future may begin releasing trade data, the following list is not a comprehensive listing of financial institutions, but a list of examples of financial institutions which may benefit from the invention. Examples of financial institutions may include but are not limited to the Chicago Mercantile Exchange, EUREX, NASDAQ, the Chicago Board of Options Exchange, Kansas City Board of Trade, the Minneapolis Grain Exchange, the International Swap Dealers Association, the International Securities Exchange, the New York Stock Exchange, the New York Mercantile Exchange, the New York Board of Trade, the German Spot Market, the German Regional Exchanges, the London Stock Exchange, the Tokyo Commodity Exchange, the Tokyo Grain Exchange, the Tokyo Commodity Exchange, the Tokyo International Financial Futures Exchange, and the Tokyo Stock Exchange.

2.2 Use of Financial Product Selection Panel

The user may select a category 106 (FIG. 1) of financial products by clicking on it. Listing of financial products 104 may be displayed in a WINDOWS collapse/expand paradigm 110. Financial products may include but are not limited to futures contracts, options contracts, and forward contracts. Financial products 120 may be organized by complex and futures type. Futures and options contracts may be located in the same category 106 or subcategory 108. Electronically traded and open outcry financial products may be included in the same category 106 or subcategory 108. For example, the user may click an expansion box 116 for a category 106 and a listing of subcategories 108 may expand underneath the selected category 106. For example, the listing of categories 106 may comprise agricultural contracts, index contracts, interest rate contracts, and metals contracts. Clicking expansion box 116 for the agricultural contracts category may cause the agricultural contracts category to expand to the subcategories 108 of corn, oats, rough rice, soybean meal, soybean oil, wheat. Clicking on expansion box 116 for the corn contracts may cause the corn contracts to expand to the financial products 120, e.g., corn futures contracts, electronic corn futures contracts, corn call option contracts, put option contracts, electronic put options contracts, electronic call options contracts, and mini-sized corn futures contracts.

Financial products selection panel 102 (FIG. 1) may give additional information for each financial product 120. The financial products selection panel 102 may list for each financial product 120 a financial product name 122, trading symbol 124, trade opening time 126, and trade closing time 128.

The user may select a financial product 120 (FIG. 1) for analysis by clicking on it within financial products selection panel 102. Single or multiple financial products 120 may be selected, e.g., the user may select to analyze 3 year and 5 year bonds. Predetermined groups of financial products may be defined by the user or defined by application 10 based on user preferences, e.g., application 10 may automatically select to analyze pit traded and an electronically traded forms of a financial product 120 together based on a user-defined preference directing application 10 to normally combine these types of financial products 120. The predetermined groups of financial products may be analyzed by selecting a predetermined group from the financial products selection panel 102, e.g., by clicking on the predetermined group in the financial products panel 102.

Application 10 (FIG. 1) may default to a predetermined financial product 120 if none is selected by the user. In addition, the user may determine a financial product 120 or group of financial products that will be analyzed by default unless a financial product 120 or group of financial products is selected by the user.

3. Selection of Trade Data

3.1 Selection of Contracts

Each financial product 120 may be traded in multiple contract terms 344 (FIG. 1). Optionally, the user may choose to limit the trade data analyzed according to the contract term (step 210, FIG. 2) by selecting one or more contract terms 344 (FIG. 1). The multiple contract terms 344 may be a predetermined group of months for each year. For example, corn futures may have contract terms of March 15^{th}, May 15^{th}, July 15^{th}, September 15^{th}, and December 15^{th}. As another example, 30 day Federal Fund Futures may have contract terms 344 that reoccur monthly on the 15^{th} for each month in a year, e.g., January 15^{th}, February 15^{th}, March 15^{th}, and etc. Contract terms 344 may repeat yearly for future years.

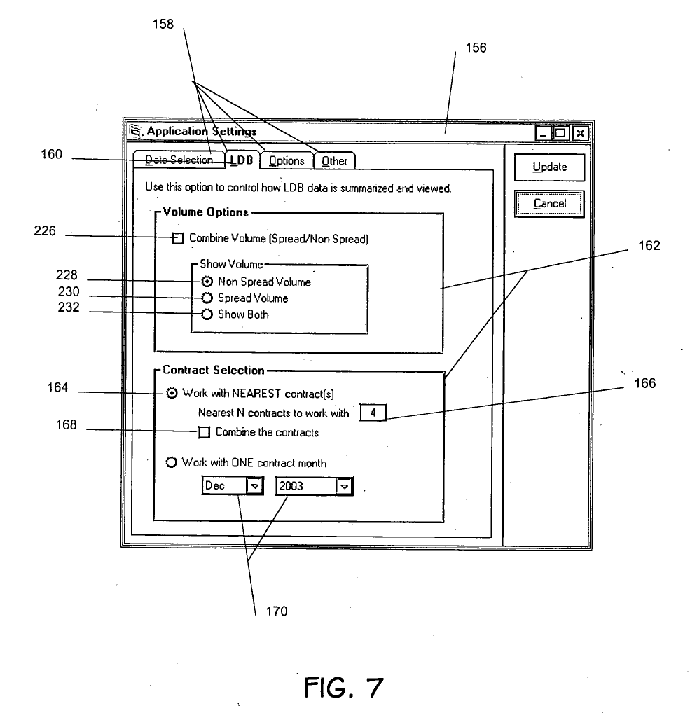

The user may select how to analyze financial products 120 having multiple contract terms 344 using an options panel. For example, clicking an options panel button 154 (FIG. 1) in application 10 may display an options window 156 (FIG. 7) with one or more tabbed option panels 158. For example, to set options for futures contracts, the user may select an LDB options panels tab 160 (FIG. 7). Application 10 then may display options for analysis of futures contracts 162.

Continuing with FIG. 7, for futures contracts, the user may select to work with only the nearest contracts by selecting a nearest contracts field, such as a nearest contracts radio button 164. The user may then enter the number of nearest contracts to work with in a nearest contracts entry field 166. Selecting the nearest contracts radio button 164 may cause application 10 to analyze only the contract terms 344 (FIG. 1) with the nearest expiration date to the current date. Entering a number in nearest contracts entry field 166 (FIG. 7) may cause application 10 to analyze the entered number of nearest contract terms. For example, if the nearest contract term is January and the user has selected 3 in nearest contracts entry field 166, application 10 may analyze January contracts and the next two contracts terms, which may be February and March if selected financial product 120 has contract terms which reoccur monthly.

The user may select to combine trade data for contract terms 344 (FIG. 1) in different years by selecting a combine contracts field, such as a combine contracts box 168 (FIG. 7). All available trade data for a contract term 344 (FIG. 1) may be used for analysis regardless of the contract term's year. For example, the user may select to analyze the nearest contract term, e.g., January, and to combine the contracts 344 (FIG. 1). Application 10 may combine trade data for January for years for which trade data is available.

The user also may have the option to determine which years will be combined when the combine contracts field is selected. More specifically the user may select a range of years for which to combine contracts 344 (FIG. 1) and trade data. For example, the user may select to combine trade data for a contract term 344, e.g., January, for the last 5 years, in which case, application 10 may combine trade data for January contracts for the selected financial product 120 (FIG. 1) or products for the last 5 years. In another example, the user may select to combine trade data for a contract term 344, e.g., January, for the years of 1945 through 2003, in which case, application 10 may combine trade data for January contracts for the selected financial product 120 or products for the years of 1945 through 2003.

The user also may select specific contract terms 344 to analyze using a contract term entry field, such as a contract entry box 170 (FIG. 7). For example, the user may select the December 2003 contract term, in which case, application 10 may analyze trade data for the December 2003 contract term for the selected financial product 120 (FIG. 1) or products.

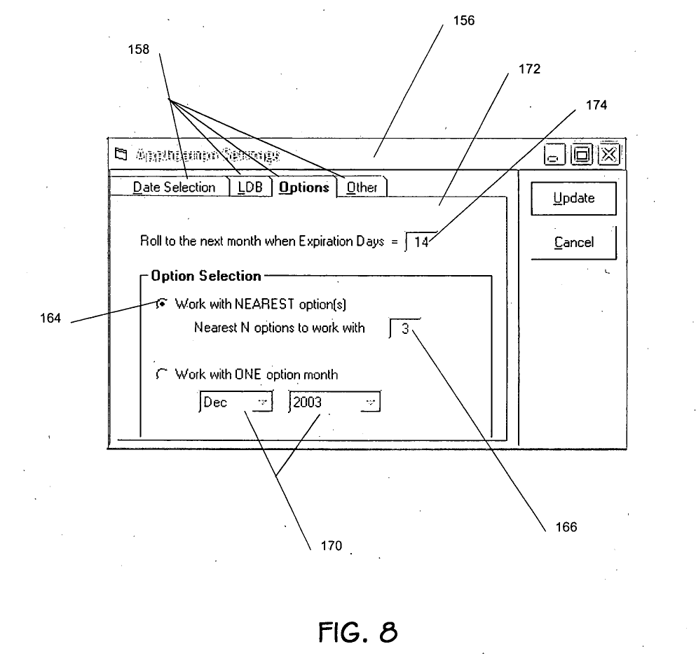

For options contracts, the user may set similar options to those set for futures contracts by using an options contracts panel 172 (FIG. 8). Selecting a nearest contracts field, such as the nearest contracts radio button 164, may cause application 10 to analyze only the contract terms 344 (FIG. 1) with the nearest expiration date to the current date. Entering a number in a nearest contracts entry field, such as a nearest contracts entry field 166 (FIG. 8), may cause the application 10 to analyze the entered number of nearest contract terms, which may be determined in the same manner described above for futures contracts.

The user also may select a contract term 344 (FIG. 1) to analyze using a contract term entry field, such as contract term entry box 170 (FIG. 8). Also, the user may select to roll to the next contract term when the next contract term expiration date is a selected time, in days, away. The user may select the number of days using a “days to roll to next contract term” field, such as a “roll to next contract term” box 174 (FIG. 8). For example, if the next contract term expires in 15 days and the user selects 16 in the “days to roll to next contract term” field, application 10 may analyze only contract terms 344 (FIG. 1) after the next expiration date because, in this example, the number of days until the next contract expires is less than the number of days selected in the “days to roll to next contract term” field.

3.2 Selection of Volume Type

Each financial product 120 (FIG. 1) may have multiple types of volume. Optionally, the user may choose to limit the trade data analyzed according to a volume type 224 (FIG. 2) by selecting one or more volume types. For example, selected financial product 120 may have spread volume and non-spread volume trade data. The user may select how application 10 analyzes these volumes. The user may select to combine the volumes (step 225, FIG. 2) by selecting a combine volume field, such as a combine volume box 226. (FIG. 7) In this case, application 10 may combine the trade data for spread volume and non-spread volume into a single combined volume.

The user also may select to analyze one or more of the types of volume separately. For example, the user may select to analyze non-spread volume by selecting a non-spread volume field, such as a non-spread volume box 228 (FIG. 7), in which case, application 10 (FIG. 1) may analyze non-spread volume trade data for the selected financial product 120 or products. In the same way, the user may select a spread volume field, such as a spread volume box 230 (FIG. 8), to analyze spread volume for the financial product 120 (FIG. 1) or products. Furthermore, the user may select a show both volumes box 232 (FIG. 7) to analyze spread and non-spread volume trade data for the financial product 120 (FIG. 1) or products. In the last case, spread and non-spread volume trade data may be analyzed simultaneously but separately for the financial product 120 or products, i.e., trade data will not be combined for the two types of volume.

3.3 Selection of Time Span

The user may select a time span (step 150, FIG. 2) over which to analyze the financial product 120 (FIG. 1) or products. The time span may be selected from a time span panel 152 (FIG. 3) in options window 156. The user may select the beginning and the end of the time span. For example, the use may enter a beginning time in a beginning time entry field, such as a from-date box 176. Also, the user may click a from-date calendar button 178 to select a begin time from a calendar 180. The user may increase or decrease the currently entered begin time, e.g., by clicking either increase or decrease from-date buttons 181.

The user may select the end of the time span for analysis by entering an end time in a to-date field, such as a to-date box 182. As with the beginning time, the user may use calendar 180 to select the end time by clicking to-date calendar box 184, or the user may increase or decrease the current end time by clicking increase or decrease to-date buttons 186. Instead of selecting an end time, the user may choose to analyze all currently available trade data for the financial product 120 (FIG. 1) or products from the beginning time though the present by selecting a go to end of data field, such as a go to end of data box 188 (FIG. 3).

3.4 Selection of Time Unit Size

The user may select a time unit size for trade data retrieval and analysis. For example, a list of predetermined time unit sizes may be displayed as a list in a time unit size drop-down box 202 (FIG. 1). The user may select a time unit size from the time unit size drop-down box 202 by clicking on the desired time unit size list entry. For example, the time unit size list may include but not be limited to 15 minutes, 30 minutes, 1 hour, 2 hours, 4 hours, daily, weekly, monthly, and yearly. Alternatively, the user may enter a time unit size in a time unit size entry field, such as a time unit size drop down box entry field 204.

The trade data may have granularity, the minimal time between records in the data source 252 (FIG. 2) for a financial product 120 (FIG. 1). Application 10 may allow time unit sizes that are equal to or larger than the trade data granularity. The granularity of the trade data may be determined by the data financial institution or the data service providing the data. Alternatively, the granularity of the trade data may be determined by the local or remote database, e.g., the local or remote database may compress the trade data by combining trade data for smaller time units, storing the combined trade data into larger time units, and then discarding the trading data for the smaller time units. So, either data source 252 (FIG. 2), which may provide trade data, or one of the sources from which it may acquire trade data may determine the granularity of the trade data.

3.5 Trade Data Granularity and Time Unit Size Relationship

The granularity of the trade data retrieved from data source 252 (FIG. 2) may affect the classification of the trade data into time units (step 300, FIG. 2) based on the trade time of the underlying trade. If the trade data granularity has a time unit size that is smaller than the selected time unit size, application 10 may combine smaller trade data granularity time units (step 1220, FIG. 2) into time units of the time unit size selected by the user, such as in the time unit size drop-down box 202 (FIG. 1). Alternatively, the data source 252 (FIG. 2) may combine trade data for smaller time unit sizes and provide trade data having the requested time unit size. If the trade data has a granularity time unit size equal to the selected time unit size, application 10 may be able to directly use the trade data without reclassifying of the trade data by time unit.

For example, the user may select a time unit size of 1 day and the trade data may be provided by data source 252 (FIG. 2) with a granularity of 15 minutes. Since, in this example, the trade data granularity time unit size is smaller than the selected time unit size of 1 day, application 10 may combine trade data for non-overlapping 15 minute time units within each day and display the combined trade data for each day in 1 day time units, i.e., each time unit may contain trade data for a 1 day subspan of the selected time span.

In another example, the user may select a time unit size of 1 hour and the trade data may be provided by the data source 252 (FIG. 2) with a granularity time unit size of 15 minutes. In this case, application 10 (FIG. 1) may combine the trade data for non-overlapping 15 minute time units falling within each 1 hour time unit.

In another example, the selected time unit size is 15 minutes and the trade data granularity time unit size is 15 minutes. In this case, the application 10 (FIG. 1) may be able to directly use the trade data without having to classify it into new or differently sized time units. If the trade data has a granularity time unit size larger than the selected time unit size, data source 252 (FIG. 2) may be unable to provide trade data for the selected time unit size and application 10 or the user may be required to increase the selected time unit size.

In another case, the selected time unit size is 15 minutes and the trade data granularity size is 1 day. In this case, data source 252 (FIG. 2) may be unable to provide the trade data at the desired time unit size. Application 10 (FIG. 1) may query trade data from another data source with a smaller trade data granularity time unit size. Alternatively, application 10 may increase the selected time unit size or request that the user increase the selected time unit size.

4. Retrieval of Trade Data

As shown in FIG. 2, after the user has selected a financial product or products (step 100), optionally selected contract terms (step 210), optionally selected volume types (step 224), and selected a time span (step 150) and time unit size (step 200), application 10 (FIG. 1) may retrieve trade data (step 254, FIG. 2) for the selected financial product 120 (FIG. 1) or products. The trade data for the financial product 120 may be identified by querying data source 252 (FIG. 2). Data sources 252 (FIG. 2) may include but are not limited to a local database, a remote database, a data server, a web server, previously loaded trade data in the application computer's memory, or a data file. In one embodiment, the trade data is retrieved from a local database for the selected financial product 120 (FIG. 1) or products.

Application 10 may query data source 252 (FIG. 2) by building a query. The query may be based on the user selected and application selected trade data limitations. For example, application 10 (FIG. 1) may build a query based on the user entered begin and end times, i.e., the selected time span; the selected contract terms 344; the selected volume types 346; and the selected time unit size.

Alternatively, the user may create a query in a database query language, e.g., a query in SQL, or application 10 (FIG. 1) may create a database query in a database query language based on user preferences, e.g., a series of selection and options that allow the user to build the query graphically. The application 10 may retrieve the trade data from the data source 252 with the query.

Alternatively, application 10 (FIG. 1) may retrieve more trade data from the data source 252 (FIG. 2) than is required for the analysis desired by the user. Application 10 (FIG. 1) may filter the trade data, e.g., by using the query, so as to analyze only those data which meet the criteria in the query.

Application 10 also may retrieve the trade data by processing one or more data files which may be indexed. The index may allow the application 10 to quickly locate trade data in the data files.

Data source 252 (FIG. 2) may be loaded with trade data during the installation of application 10, from a remote data or update service, from a remote database, from a data provider, or from a financial institution. A process for retrieving the trade data and updating a database of trade data is described in the section “REFRESHING TRADE DATA.”

5. Time Unit Panel

5.1 Time Unit Table

Trade data for the selected financial product 120 (FIG. 1) or products for the selected time span may be displayed in the time unit panel 326 as shown in FIG. 1. The time unit panel 326 may display, e.g., in fields, descriptions of the trade data being analyzed and the criteria used in selecting the trade data. Financial product name 122 may be displayed in a product name field 330, the trade data time unit size may be displayed in a time unit size field 332, the volume type may be displayed in a volume type field 334, and the number of near contract to analyze may be displayed in a near contracts field 336.

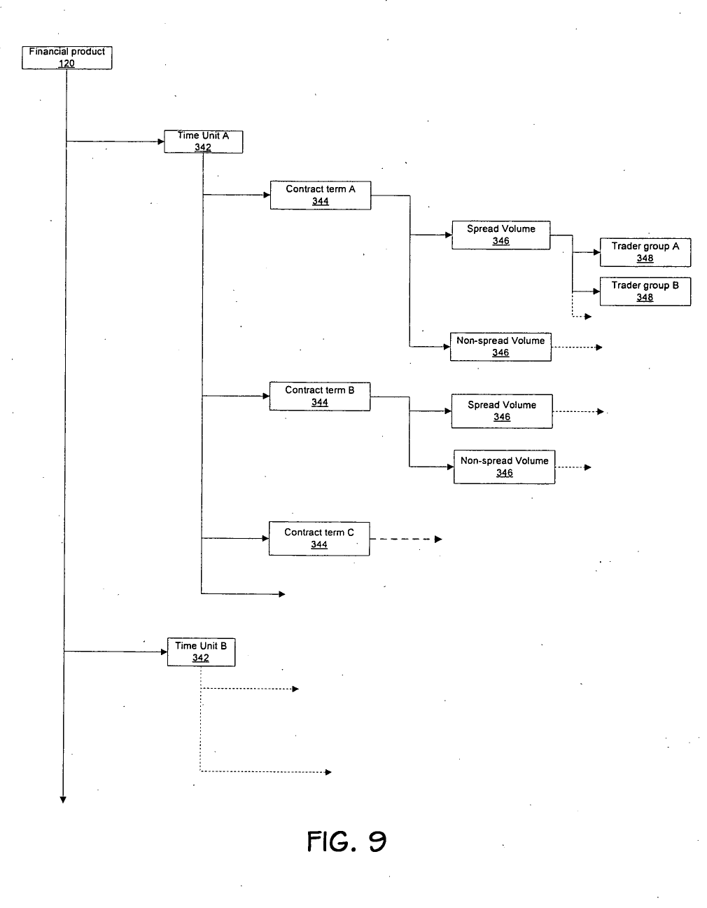

The trade data may be displayed in a time unit table 328 (FIG. 1) in the time unit panel 326. The user may click a print time unit table button 338 to print the trade data in the time unit table 328. The trade data may be classified into rows 340 in the time unit table 328. Each row 340 in the time unit table 328 may represent a unique combination of financial product 120, time unit 342, contract term 344, and volume type 346. Alternatively, each row 340 may represent a unique combination of financial product 120, time unit 342, contract term 344, volume type 346, and trader group 348. The trade data may be classified in the rows 340 using the organization shown in FIG. 9, wherein for each financial product 120, a row 340 may be added for each unique time unit 342. If the unique time unit 342 has multiple contract terms 344, each contract term 344 may be in a separate row 340. If each contract term 344 has multiple volume types 346, e.g., spread volume and non-spread volume, each volume type may be in a separate row 340.

Multiple trader groups may be displayed on the same row 340 in separate columns 350 (FIG. 1). Alternatively, trade data for each trader group 348 may be displayed in a separate row 340. The trader groups 348 may be predetermined by application 10, a financial institution, a data provider, a remote database, or the local database. The trader groups 348 may be trade board members, institutional traders, trade board members trading with other members, and other traders not falling into one of the first three groups. The trader groups may be represented by the names CTI1, CTI2, CTI3, and CT4, respectively.

If more rows 340 (FIG. 1) of trade data are available for the financial product 120 than may be displayed simultaneously in the time unit table 328, application 10 may allow the user to scroll through rows 340 using a time unit table row scroll bar 352. Application 10 may retrieve trade data from the data source dynamically as the time unit table row scroll bar 352 is moved. For example, if more rows 340 of trade data are available for the financial product 120 and selected search criteria than what can be displayed in the time unit table 328, application 10 may retrieve trade data for just the rows 340 currently displayed. As time unit table row scroll bar 352 is moved, application 10 may retrieve new trade data from data source 252 (FIG. 2) in order to populate rows 340 (FIG. 1) that are newly displayed. This method of delaying the retrieval of trade data until it is necessary for display may substantially increase the speed at which trade data may be displayed by decreasing the quantity of trade data retrieved at one time from data source 252 (FIG. 2).

The trade data for each row 340 (FIG. 1) may be displayed on the time unit table 328 classified into columns. The user may select to sort the trade data by the one or more columns. The user may sort a column by clicking on a column header 354. Each subsequent click on the same column header 354 may alternate the sorting of the trade data between ascending and descending order based on the column corresponding to the clicked column header 354. The user may select to change the order in which the columns are displayed across the time unit table 328 by clicking and dragging the column headers 354 into the desired order. The user may change the width of each column by clicking and dragging edges 356 of a column to the desired width. Application 10 may set the column widths so as to best display the trade data.

The user may select which columns of trade data to show from a list of predetermined columns of trade data. The user may select to display columns of statistical measures. Also, the user may enter calculations or database queries to create custom columns which may be displayed. Also, the user may select predetermined groups of columns to show using a drop-down column group box 358 (FIG. 1).

The predetermined groups of columns may be determined by the type of financial product 120 (FIG. 1) being analyzed. For example, if the financial product 120 is a futures contract, application 10 may allow the user to select a predetermined group of columns that includes settlement prices or a predetermined group of columns that includes volume summaries. In another example, financial product 120 is an options contract, and application 10 may allow the user to select a predetermined group of columns that includes options summaries.

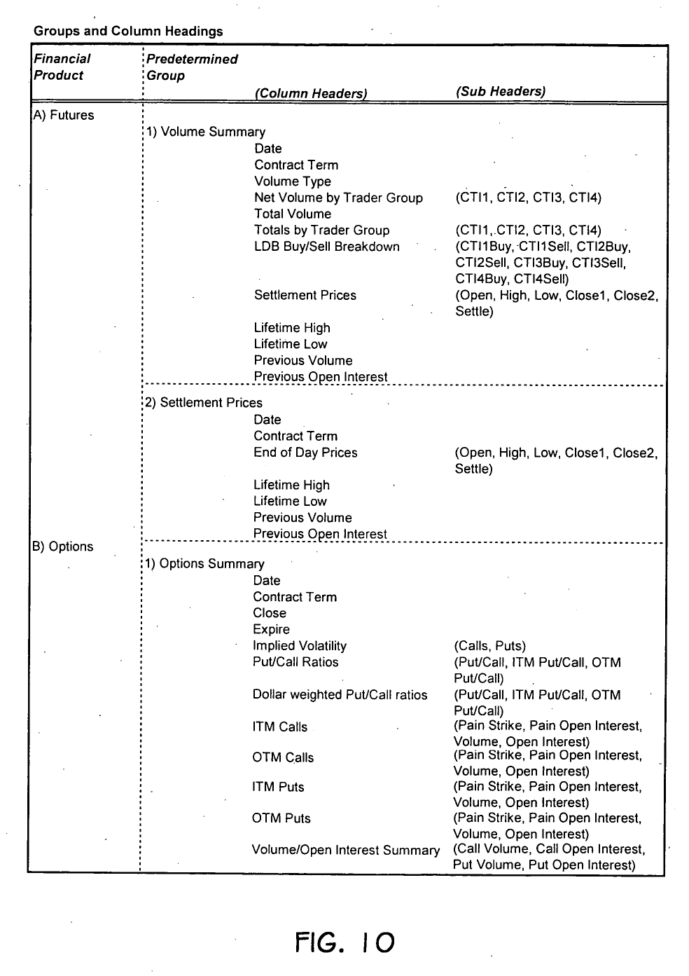

Application 10 (FIG. 1) may change which columns are displayed depending on the type of financial product 120 being analyzed. For example, application 10 may select, without user intervention, columns displaying put to call ratios if the financial product 120 is an option contract. In another example, application 10 may select columns displaying settlement prices if financial product 120 is a futures contract. FIG. 10 lists default columns and predetermined groups of columns application 10 may display for different financial product types. If more columns are selected than the display or application width will allow to be displayed simultaneously, application 10 may allow the user to scroll the columns using a time unit table column scroll bar 360.

Time units 342 (FIG. 1), contract terms 344, and volume types 346 may be included as columns in the time unit table 328. The trade data may be classified according to one or more trader groups 348 in separate columns. The trade data displayed in the time unit table 328 may include volume data. The displayed volume data may include total trade volume data. The displayed volume data also may include net trade volume data. The volume data may include separate columns of buy and sell volume data.

The trade data displayed in the price time unit table 328 (FIG. 1) may include price data. The displayed price data may include a low trading price and a high trading price. Also, the displayed price data may include a lifetime high trading price and a lifetime low trading price. Furthermore, the displayed trading data may include one or more end of day settlement prices.

The trade data displayed on time unit table 328 (FIG. 1) may include statistical measures. The statistical measures may be determined in part from the trade data. The displayed statistical measures may be determined by application 10 as needed, from a database query, or by a server.

The displayed statistical measures may include put and call option implied volatility. The displayed statistical measures may include put to call ratios. In addition, the displayed put to call ratios may include in-the-money (ITM) and out-of-the-money (OTM) put to call ratios. The displayed statistical measures may include dollar weighted put to call ratios. The displayed dollar weighted put to call ratios may include ITM and OTM dollar weighted put to call ratios.

The displayed statistical measures may include open interests. The displayed open interests may include ITM and OTM open interests. The displayed statistical measures may include dollar weighted open interests. The displayed dollar weighted open interests may include dollar weighted ITM and OTM open interests.

The displayed statistical measures may include pain strike prices. The displayed pain strike prices may include ITM and OTM pain strike prices. The displayed statistical measures may include pain open interests. The displayed pain open interests may include ITM and OTM pain open interests.

The displayed statistical measures may include a composite implied volatility. In addition, the displayed statistical measures may include a modified composite implied volatility, wherein the modified implied volatility is determined considering only the ITM option strike price nearest to the ending trade price and the three OTM option strike prices nearest to the ending trade price for each time unit. The displayed statistical measures also may include Greek statistics. The Greek statistics for the trade data may include but are not limited to delta, gamma, lamda, rho, theta, vega, and zeta. The statistical measures may be determined from trade data as described in “STATISTICAL CALCULATIONS” section.

Rows 340 (FIG. 1), columns, or individual cells 362 in the time unit table 328 may contain symbols, colored text, or patterns to emphasize the values in the rows 340, columns, or individual cells 362, i.e., emphasizing those trade data or providing additional information to the user about those trade data. For example, a cell 362 that contains a trade data value that is higher than the same trade data for the previous time unit may be emphasized, and, more specifically, it may contain a graphic of an upwardly pointing arrow, and, still more specifically, the upwardly pointing arrow may be green. A cell 362 that contains a trade data value which is lower than the same trade data for the previous time unit may be emphasized, and, more specifically, it may contain a graphic of a downwardly pointing arrow, and, still more specifically, the downwardly pointing arrow may be red. As another example, a cell 362 that contains a volume trade data value that is negative may be emphasized, and, more specifically, the value may be red.

5.2 Time Unit Graph

Trade data for the selected time span also may be displayed in time unit panel 326 in a time unit graph 370 (FIG. 5). The user may display time unit graph 370 by clicking a time unit graph view button 373 (FIG. 1). The user may return to the time unit table 328 by clicking a return to time unit table button 371 (FIG. 5). The user may print the time unit graph 370 (FIG. 5) by clicking a print time unit graph button 372.

Time unit graph 370 may have a time axis 374 with labels 376 for one or more time units 342 in the selected time span. Not all time units in the selected time span may have a label 376. Time unit graph 370 may not display all trade data for the selected time span at once. The user may use a time unit graph scroll bar 378 to scroll through the trade data for the selected time span. Application 10 may retrieve trade data only as necessary in order to display it in a similar manner as the time unit table row scroll bar 352 (FIG. 1). The user may zoom sections of time unit graph 370 by using a zoom-in button 380 (FIG. 5) and a zoom-out button 382. The user may restore the original zoom using a return-zoom button 384.

Trade data may be plotted on time unit graph 370 (FIG. 5) with respect to one or more trade data axes 386 (FIG. 5). The user may select one or more trade data or statistical measures from a predetermined list which may be plotted on time unit graph 370. The user may select groups of predetermined trade data using a graph data group box 388. The trade data columns from time unit table 328 (FIG. 1) may be available for plotting. Also, the user may enter a calculation or a database query for trade data which may be plotted on the time unit graph 370 (FIG. 5).

Trade data that may be available for plotting for financial product 120 may include total volume, CTI1 total volume, CTI2 total volume, CTI3 total volume, CTI4 total volume, net volume, CTI1 net volume, CTI2 net volume, CTI3 net volume, CTI4 net volume, CTI1 buy volume, CTI2 buy volume, CTI3 buy volume, CTI4 buy volume, CTI1 sell volume, CTI2 sell volume, CTI3 sell volume, CTI4 sell volume, close price, open price, high price, low price, and settle price.

The trade data plotted on time unit graph 370 (FIG. 5) may include statistical measures. The statistical measures may be determined in part from the trade data. The graphed statistical measures may be determined by application 10, from a database query or by a server. One or more of the statistical measures that are available as columns in the time unit table 328 (FIG. 1) may be plotted in the time unit graph 370 (FIG. 5).

The trade data graphed on time unit graph 370 (FIG. 5) also may include volume data. The graphed volume data may include the total trade volume data or the net trade volume data. Also the graphed volume data may include buy volume or sell volume. Volume data for individual trader groups 348 may be plotted. For example, the user may select to plot the volume data for one or more of the trader groups 348. The volume data also may be plotted on a second graph 390 in time unit panel 326. The user may select the trade data to plot in second graph 390 using a second graph data selection drop-down box 392.

The trade data plotted on time unit graph 370 (FIG. 5) may include price data. The price data may include one or more of the following types of price data: low trading price, high trading price, lifetime high trading price, and lifetime low trading price. The plotted price trading data may include one or more end of day settlement prices.

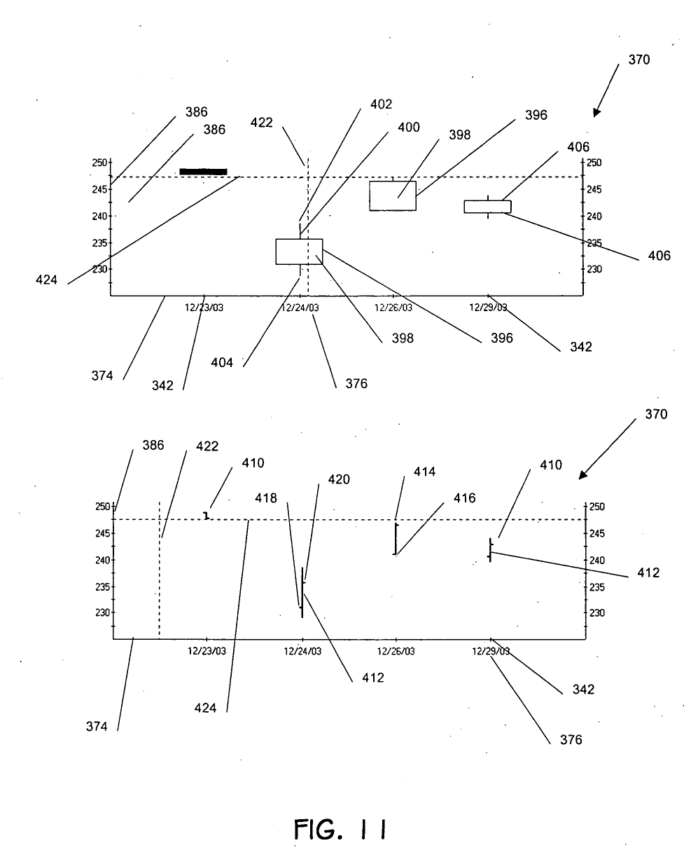

The price data for each time unit may be plotted on the time unit graph 370 (FIG. 5) as a candlestick 396 (FIG. 11) by clicking a candlestick button 394 (FIG. 5). Candlestick 396 (FIG. 11) may be a box 398 with a vertical line 400 through box 398, wherein the top 402 of vertical line 400 may represent, in reference to trade data axis 386, the highest price for financial product 120 or products during each time unit and bottom 404 of vertical line 400 may represent the lowest price for financial product or products for each time unit. The ends 406 of box 398 may represent the opening and closing prices of the financial product for each time unit, and the color or pattern of box 398 may represent whether the price at the end of the time unit was higher or lower than it was at the beginning of the time unit. Box 398 may be solid black when the price at the end of the time unit is lower than the price at the beginning of the time period, or the box 398 may be outlined with a white interior when the price at the end of the time unit is higher than the price at the beginning of the time unit.

The price data for each time unit may be plotted on time unit graph 370 (FIG. 5) as an OHLC bar 410 (FIG. 11) by clicking an OHLC button 408 (FIG. 5). The OHLC bar 410 (FIG. 11) may be a vertical line 412, wherein top 414 of vertical line 412 may represent, in reference to trade data axis 386, the highest price for the financial product 120 or products during each time unit and bottom 416 of vertical line 412 may represent the lowest price for financial product 120 or products for each time unit. OHLC bar 410 may have an open line 418 and a close line 420. Open line 418 may be a short horizontal line that extends perpendicularly from vertical line 412 and to the left at a position on OHLC bar 410 which corresponds to the opening price with respect to trade data axis 386. Close line 420 may be a short horizontal line that extends perpendicularly from vertical line 412 and to the right at a position on OHLC bar 410 which corresponds to the closing price with respect to trade data axis 386.

5.3 Export Time Unit Trade Data

Time unit table 328 (FIG. 1) and time unit graph 370 (FIG. 5) produced by application 10 may be exported for further analysis, storage, of publication. In addition, the trade data displayed in time unit table 328 and time unit graph 370 may be exported by the user in a form convenient for further analysis, storage, or publication, e.g., such as exporting to a spreadsheet program such as MICROSOFT EXCEL or publishing program such as MICROSOFT POWERPOINT, MICROSOFT PUBLISHER, or MICROSOFT WORD.

6. Price Zone Panel

Trade data for selected financial product 120 or products for a price zone time span may be displayed in a price zone panel 502 as shown in FIG. 1. The beginning and end of the price zone time span may be determined in part from user interaction with time unit panel 326 as described in the section “INTERACTION.”

6.1 Classification into Price Zones

The trading data for the selected price zone time span and selected financial product 120 (FIG. 5) or products may be classified into a number of price zones 554 in price zone panel 502. A method of classification is shown in block form in FIG. 4A. A high and low price for trade data in the price zone time span may be determined by application 10 (FIG. 1), or the user may manually select a high price and a low price. Application 10 may classify the trade data (step 500, FIG. 4A) into a number of non-overlapping, uniform sized price zones between the high and low price. The user may select the number of price zones (step 504), e.g., by using a prize zone count entry field 505 (FIG. 5), between the high and low price and application 10 may determine the size of each price zone (step 506. FIG. 4A) by dividing the difference of the high and low prices by the number of price zones. Alternatively, the user may select the size of each price zone collectively or individually and each price zone may be non-uniform in size. For example, the user may select that all price zones are a specified dollar amount in size, or the user may select the limits of each price zone individually. Also, each price zone 554 (FIG. 5) may be a discrete price (see 554, FIG. 1), a range of prices (see 554, FIG. 5), or a discrete option strike price from the trading data for the price zone time span and selected financial product 120 or products.

6.2 Price Zone Table

The trade data for the price zone time span for the select financial product 120 (FIG. 1) or products may be displayed in price zone panel 502 as a price zone table 510. The user may print price zone table 510 (FIG. 1) by clicking a print price zone table button 511. Price zone table 510 may contain multiple rows 512 wherein each row 512 represents an individual price zone 554 (FIG. 1). The trade data for each price zone 554 may be displayed on time unit table 510 classified into one or more columns 514. The user may select which columns 514 of trade data to show from a list of predetermined columns of trade data. The user may select to display columns of statistical measures. Also, the user may enter calculations or database queries to create custom columns which may be displayed.

The predetermined columns to be displayed may be determined by the type of financial product 120 (FIG. 1) being analyzed. For example, if financial product 120 is a futures contract, application 10 may display columns 514 comprising price zone, discrete price, total volume, CTI1 total volume, CTI2 total volume, CTI3 total volume, CTI4 total volume, net volume, CTI1 net volume, CTI2 net volume, CTI3 net volume, CTI4 net volume, CTI1 buy volume, CT12 buy volume, CTI3 buy volume, CTI4 buy volume, CTI1 sell volume, CTI2 sell volume, CTI3 sell volume, and CTI4 sell volume.

If financial product 120 (FIG. 1) in an option contract, application 10 may show columns 514 comprising strike price, previous price, close price, open price, high price, low price, and settle price. The user also may, for an options contract, select to display open interest trade data. Columns 514 of open interest trade data may comprise strike price, last price, previous price, total volume, total open interest, pit volume, ETS, give ups, transfers, adjustments, implied volatility, and Greeks. Greeks may include but are not limited to delta, gamma, lamda, rho, theta, vega, and zeta.

The user may select from predetermined groups of columns using a price zone table drop-down box 516 (FIG. 1). Price zone table drop-down box 516 may also allow the user to display the trade data classified into either price zones 554 having an upper and lower range or as discrete prices, i.e., each discrete price is price zone having an upper and lower bound equal to a discrete price. Trade data displayed in the price zone table 510 are described in more detail below.

The trade data displayed in price zone panel 502 (FIG. 1) may include volume data. The displayed volume data may include total trade volume data. Also, the displayed volume data may include net trade volume data. The displayed volume data may be classified into buy and the sell volume data. The displayed trade data may include price data. The displayed price data may include a low trading price and a high trading price. Also, the displayed price data may include lifetime high trading price data and lifetime low trading price data. The displayed trading data may include one or more end of day settlement prices. A column 514 in price zone table 510 may display the high and low price within the price zone 554 corresponding to a row 512, i.e., a price zone 554, or a row 512 in price zone table 510 may display a discrete price or discrete strike price corresponding to that row 512.

Open interest volume data for the price zone time span for selected financial product 120 (FIG. 1) or products may be displayed on the price zone table 510 for each price zone 554. The displayed open interest volume data may include last premium and previous premium. Also, the open interest volume data may include total volume, pit volume, and electronic trading system volume. The displayed open interest volume data may include give-ups. Also, the displayed open interest volume data may include transfers. Also, the displayed open interest volume data may include adjustments.

Rows 512 (FIG. 1), columns 514, or individual cells 518 in price zone table 510 may contain symbols, colored text, or patterns to emphasize the values in the rows 512, columns 514, or individual cells 518, i.e., emphasizing those trade data or providing additional information to the user about those trade data. For example, cells 518 containing strike prices that are ITM may be emphasized, and more specifically may be shaded green. Cells 518 containing strike prices that are OTM may be emphasized, and more specifically may be shaded red.

6.3 Price Zone Graph

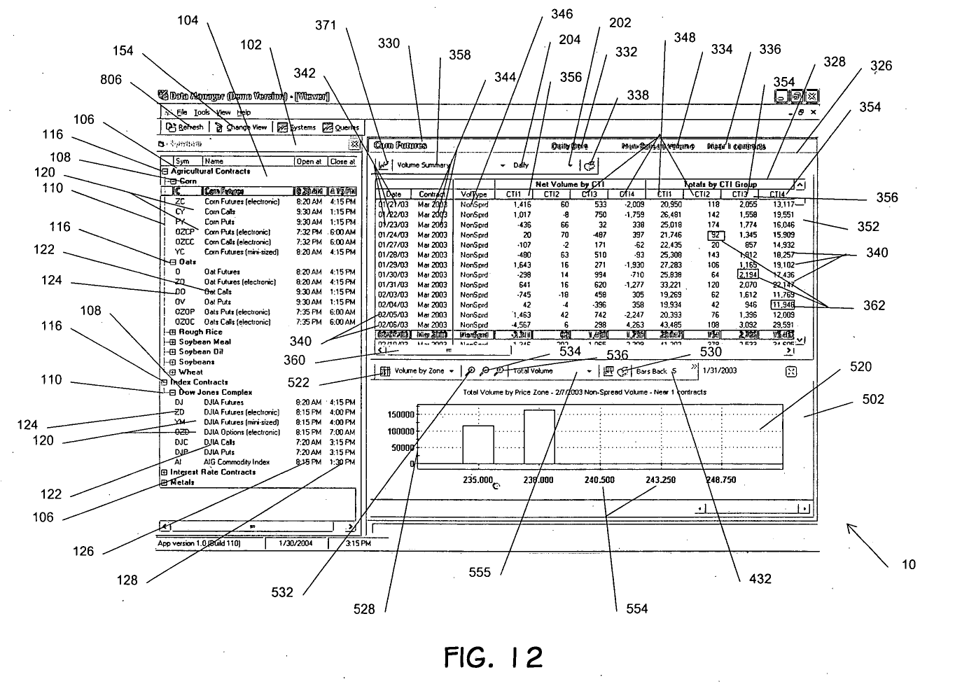

Trade data for each price zone 554 for the price zone time span for selected financial product 120 or products may be displayed in a price zone graph 520 (FIG. 12). The user may alternate between price zone graph 520 and price zone table 510 by clicking a price zone table display button 522 and a price zone graph display button 524. The user may print price zone graph 520 (FIG. 12) by clicking thae print price zone graph button 530. The user may zoom sections of the graph by using a zoom-in button 532 (FIG. 5) and a zoom-out button 534. The user may restore the original graph size using a return-zoom button 536.

Price zone graph 520 may have a price axis 526 with divisions for one or more price zones 554. The user or application 10 may determine the distribution and size of each price zone 554 (FIG. 12) in the manner described above for price zone table 510 (FIG. 1). Price zone graph 520 (FIG. 12) may have a data axis 528 where the user may select one or more trade data to be graphed versus price zones 554. The user may select trade data, calculations, and statistical measures including but not limited trade data columns listed above from the price zone table 510. The user may select what trade data to plot using a price zone graph data select field, e.g., a price zone graph drop-down box 555.

The trade data displayed in price zone graph 520 (FIG. 1) may include volume data. The plotted volume data may include total trade volume data. Also, the plotted volume data may include net trade volume data. The plotted volume data may be classified into buy and the sell volume data. The plotted open interest volume data may include total volume, pit volume, and electronic trading system volume. The plotted open interest volume data may include give-ups. Also, the plotted open interest volume data may include transfers. Furthermore, the plotted open interest volume data may include adjustments.

6.4 Exporting Price Zone Trade Data

Price zone table 510 (FIG. 1) and price zone graph 520 (FIG. 12) produced by application 10 may be exported for further analysis, storage of publication. In addition, the trade data displayed in price zone table 510 and price zone graph 520 may be exported by the user in a form convenient for further analysis, storage, or publication, e.g., exported to a spreadsheet program such as MICROSOFT EXCEL or publishing program such as MICROSOFT POWERPOINT, MICROSOFT PUBLISHER, or MICROSOFT WORD.

7. Interaction

7.1 Time Unit Panel to Price Zone Panel

Price zone panel 502 (FIG. 1) and time unit panel 326 may interact, e.g., a user selection in one panel may determine what trade data is displayed in the other panel or may affect the manner is which trade data is presented in the other panel. A process application 10 may follow is outlined in block form in FIGS. 4A and 4B.

The user may select the end of the price zone time span by selecting a time unit 342 from time unit panel 362 (FIG. 1). For example, the user may select a row 340 in the time unit table 342. Selected row 340 may correspond to a financial product 120, time unit 342, contract term 344, and volume type 346. The end of the price zone time span may be set to the end of the time unit corresponding to the selected row 340.

Application 10 (FIG. 1) may restrict trade data displayed in the price zone panel 502 based on selected row 340. For example, if selected row 340 is for trade data with a volume type 346 of spread, price zone panel 502 may display trade data having spread volume. In the case that selected row 340 is for non-spread volume, price zone panel 502 may display trade data having non-spread volume. If selected row 340 is for combined volume, price zone panel 502 may display trade data for combined volume. If selected financial product 120 has multiple contract terms 344, the trade data displayed in price zone panel 502 may be restricted to trade data for a contract term 344 corresponding to the contract term 344 of the row 340 selected in the time unit table 328.

Alternatively, the user may select the end of the price zone time span by selecting a time unit 342 in time unit graph 370 in time unit panel 326. The user may click on a time unit 342 on time unit graph axis 374. The user also may click on the time unit graph 370 above the axis 374, and the time unit 342 immediately underneath where the user clicked may be used to determine the end of the price zone time span. Also, the user may click on a data point on the time unit graph 370, e.g., a candlestick 396 (FIG. 11) or a OHLC bar 410, and the time unit corresponding to the data point that the user clicked on may be used to determine the end of the price zone time span.

Application 10 (FIG. 5) may draw a time line 422 on time unit graph 370 when the user clicks time unit graph 370. Time line 422 may intersect any point on the time unit graph 370 which corresponds to selected time unit 342 by clicking time unit graph 370. Time line 422 (FIG. 5) may be drawn on second time unit graph 390 at a position on second time unit graph 390 which corresponds to selected time unit 342. At the same time, a horizontal line 424 may be drawn on time unit graph 370 which intersects any points having a trade data value equal to the trade data value of the position at which the user clicked on time unit graph 370 with respect to trade data axis 386. As with time unit table 328, the end of the price zone time span may be set to the end of selected time unit 342.

The user also may select a beginning of the price zone time span. A time unit 342 (FIG. 5) may be selected from time unit graph 370 or time unit table 328 (FIG. 1). For example, the user may select several time units 342 in time unit table 328 and application 10 may set the beginning of the price zone time span to the start of the oldest selected time unit 342 and set the end of the price zone time span to the end of the newest selected time unit 342. As another example, the user may click on time unit graph 370 and drag a pointing device across several time units 342 before releasing the pointing device. Application 10 may set the beginning of the price zone time span to the start of the older of the two selected time units 342 and the end of the price zone time span to the end of the newer of the two selected time units 342, i.e., one selected time unit 342 may be where the user initially clicks with the pointing device and the second selected time unit 342 may be where the user releases the pointing device.

Alternatively, instead of selecting a time unit 342 (FIG. 1) in order to determine beginning start of the price zone time span, the user may select a number of historical time units (step 432, FIG. 4A), e.g., using a historical time unit selection box 432 (FIG. 1). The beginning of the price zone time span may be determined by subtracting the selected number of historical time units from the end of the price zone time span. Time units which fall outside trading times for the selected financial product 120 or products, i.e., outside the trade opening time 126 (FIG. 1) and trade closing times 128, may not be included in determining the start of the price zone time span. Application 10 may determine the opening 126 and closing times 128 for a financial product 120 from data source 252 (FIG. 2). Also, the user may specify opening 126 (FIG. 1) and closing 128 times and trading days for a financial product 120.

As an example, the user may select a time unit corresponding to a Tuesday, a time unit size of 1 day, and two historical time units. The end of the price zone time span will be set to the end of trading of the financial product on Tuesday. The beginning of the price zone time span may be set to two time units before the end of the time span. If financial product 120 is not traded during weekends, application 10 may set the beginning of the price zone time span to trade opening time 126 on the Friday immediately preceding Tuesday. Thus, the price zone time span will include trade data for Tuesday, Monday, and Friday. If the Monday is a holiday or trade is suspended for the financial product 120 for that day, the application 10 may set the beginning of the price zone time span to opening time 126 of trading on the Thursday immediately preceding the Tuesday.

Application 10 may determine the beginning of the price zone time span in a similar manner for time unit sizes other than days. In another example, the time unit size is 1 hour, 2 historical time units, the user has selected Monday at 10 AM as the end of the price zone time span, and the selected financial product is traded from 9 AM until 2 PM. Application 10 may subtract 2 hours from 10 AM for a result of 8 AM. But since trading did not open until 9 AM, application 10 may go to the close of trading from the previous trading day, e.g., the previous Friday, and continue subtracting. In this case, the beginning of the price zone time span will be set to 3 PM on the previous Friday. The process is shown in block form in FIG. 4, steps 434-444 and described in the section “FLOWCHARTS.”

After the user has selected a time unit 342 (FIG. 1) in the time unit panel 326, the trade data corresponding to time units 342 in the price zone time span may be emphasized on the time unit panel 326. For example, after a price zone time span is selected using time unit table 328, the rows 340 containing trade data with time units within the price zone time span and having the same volume type and the same contract term as the price zone trade data may be highlighted. Alternatively, only rows 340 selected by the user, which were used to determine the end of the price zone time span, may be highlighted. If the time unit graph 370 (FIG. 5) is displayed, the trade data corresponding to the price zone time span may be highlighted. Alternatively, only the trade data corresponding to selected time 342 unit used to determine the end of the price zone time span may be highlighted. The highlighting of trade data in the time unit graph may comprise a shaded area or multiple time lines 422 which outline a portion of time unit graph 370.

7.2 Price Zone Panel to Time Unit Panel

Price zone panel 502 may interact with time unit panel 326 as shown in FIG. 4B. The user may select at least one price zone 554 in price zone table 510 by clicking on one or more rows 512 corresponding to price zones 554. The user may select at least one price zone 554 in price zone graph 520 (FIG. 12) by clicking on or above a price zone 554 on price zone graph 520 or by clicking on a data point and the corresponding price zone 554 may be selected by application 10.

Selecting at least one price zone 554 in price zone table 510 (FIG. 1) or price zone graph 520 (FIG. 12) may emphasize trade data in time unit table 328 or time unit graph 370. A process for identifying and emphasizing trade data in the time unit graph 370 is outlined in block form in FIG. 4A. If prices are displayed on time unit graph 370 (FIG. 5), the action of selecting a price zone (steps 600a-b, FIG. 4B) may cause application 10 to draw price line 602 (FIG. 5) on time unit graph 370 at a position on which corresponds to prices within selected price zone 554. Price line 602 may be drawn as a band which emphasizes a range of prices that correspond to a selected price zone 554 in the price zone panel 502. If multiple price zones are selected in price zone table 510 or price zone graph 520 (FIG. 12), price lines 602 (FIG. 5) may emphasize a range of prices that correspond to the range of selected price zone 554.

A strike price line may be drawn on the time unit graph 370 corresponding to a selected strike price in price zone graph 520 (FIG. 12) or price zone table 510 (FIG. 5). In addition, an option open interest price line may be drawn on time unit graph 370 corresponding to an option open interest price selected in price zone graph 520 (FIG. 12) or price zone table 510 (FIG. 5).

8. Volume Event Graph

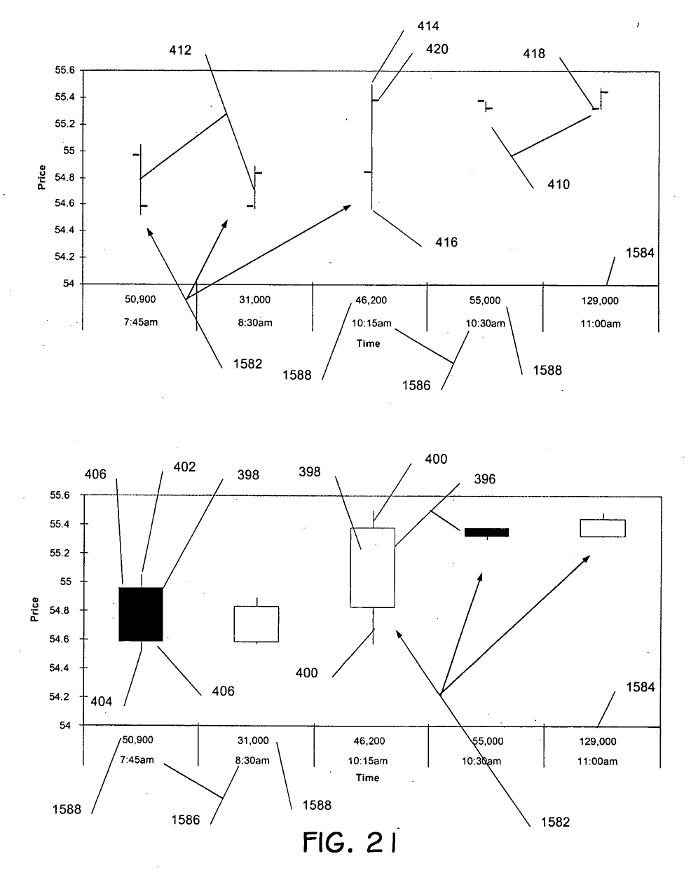

Trade data for selected financial product 120 for the selected time span may be displayed in a volume event graph 1500 as shown in FIG. 21. Volume event graph 1500 may show trade data classified into one or more volume event groups 1582 for a selected time span.

To display volume event graph 1500, the user may select a financial product, e.g., by using financial product selection panel 102 (FIG. 1), select a time span, e.g., by using time span panel 152 (FIG. 3), a volume group, e.g., by using a volume group trade data selection field, and a volume trigger event, e.g., by using a volume trigger entry field.

The volume groups may include but are not limited to volume columns which may be available in time unit table 328 and price zone table 510. Volume groups also may include total volume, CTI1 total volume, CTI2 total volume, CTI3 total volume, CTI4 total volume, net volume, CTI1 net volume, CT12 net volume, CTI3 net volume, CTI4 net volume, CTI1 buy volume, CTI2 buy volume, CTI3 buy volume, CTI4 buy volume, CTI1 sell volume, CT12 sell volume, CTI3 sell volume, and CTI4 sell volume.

After selecting financial product 120, a time span, and a volume, application 10 may determine trade data. The trade data may be classified into volume event groups 1582 based on the volume event trigger. Application 10 may begin examining trade data at the beginning of the selected time span and accumulate volume data in an accumulated volume register until the accumulated volume register is greater than or equal to the volume event trigger. Application 10 then may create a volume event group 1582. A method which application 10 may use is described in detail in the section “FLOWCHARTS.”

Application 10 may plot volume event groups 1582 in volume event graph 1500. Each volume event group 1582 may be plotted as an OHLC bar 412 (FIG. 21) or as a candlestick 398 (FIG. 21) on volume event graph 1500 (FIG. 21), wherein the position of OHLC bar 412 or candlestick 398 for each volume event group 1582, with respect to a time axis 1584 (FIG. 21), may correspond to the begin and end times of each volume event group 1582. The begin time and end time 1586 of each volume event group 1582 may be displayed on volume event graph 1500. The accumulated volume 1588 for each volume event group 1582 may be displayed on volume event graph 1500. Alternatively, the total accumulated volume for the selected time span though each volume event group 1582 may be displayed on volume event group graph 1500.

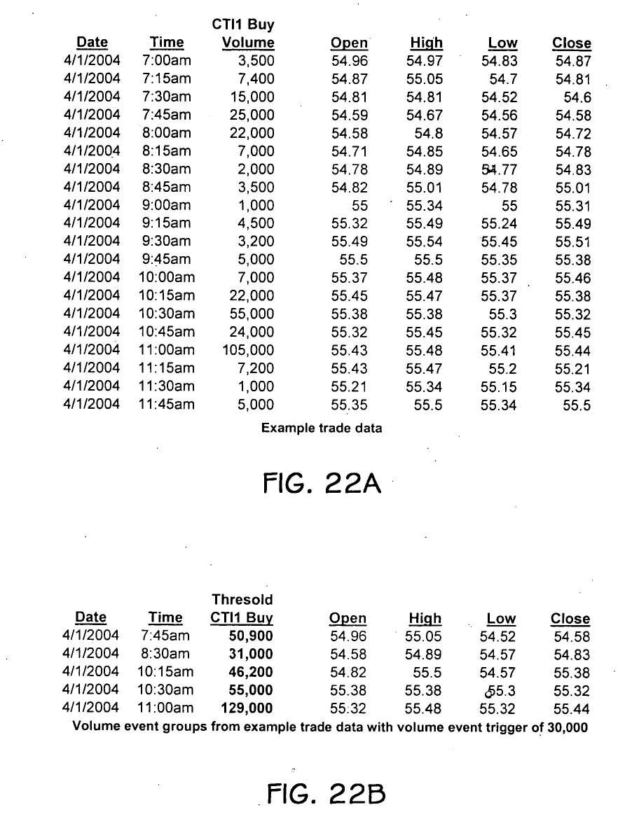

FIG. 22A provides an example of trade data that may be displayed in volume event graph 1500. In this case, a volume event trigger of 30,000 and a volume group of CTI1 buy volume may be selected by the user. Application 10 may accumulate trade volumes through 7:45 AM, when the accumulated volume register is equal to 50,900 (FIG. 22B). Application 10 may add the accumulated volume register to a total accumulated volume register and reset the accumulated volume register. Application 10 then may create a volume event group 1582 (FIG. 21) having an accumulated volume 1588 equal to 50,900 and an end time 1586 equal to 7:45 AM. The 7:45 AM volume event group 1588 may be plotted as an OHLC bar 412 with open, close, high, and low prices (see FIG. 22B) determined from the trade data (FIG. 22A).

Continuing the above example, application 10 may continue accumulating trade volume (FIG. 22A) until the accumulated volume register is equal to 31,000 at 8:30 AM (FIG. 22B). Application 10 then may create a volume event group 1582 (FIG. 21) having an accumulated volume 1588 equal to 31,000 and an end time 1586 equal to 8:30 AM. The 8:30 AM volume event group 1588 (FIG. 21) may be plotted as an OHLC bar 412 with open, close, high, and low prices (see FIG. 22B) determined from trade data (FIG. 22A) since the previous volume event group 1582.

This process may continue though the end of trade data or the end of the selected time span. Application 10 may determine volume event groups 1588 in the selected time span and plot them on volume event group graph 1500.

9. Statistical Calculations

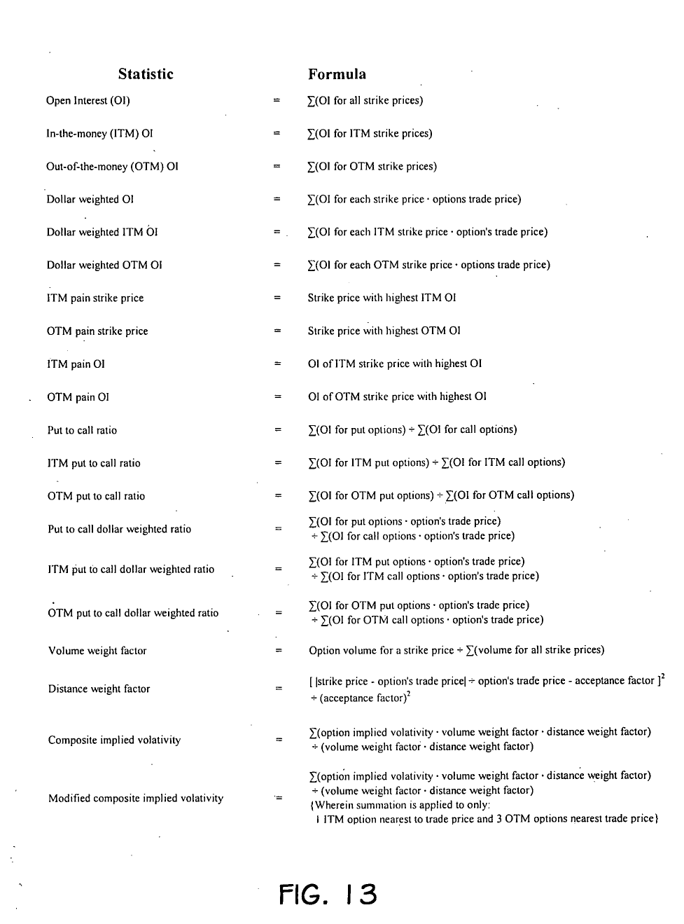

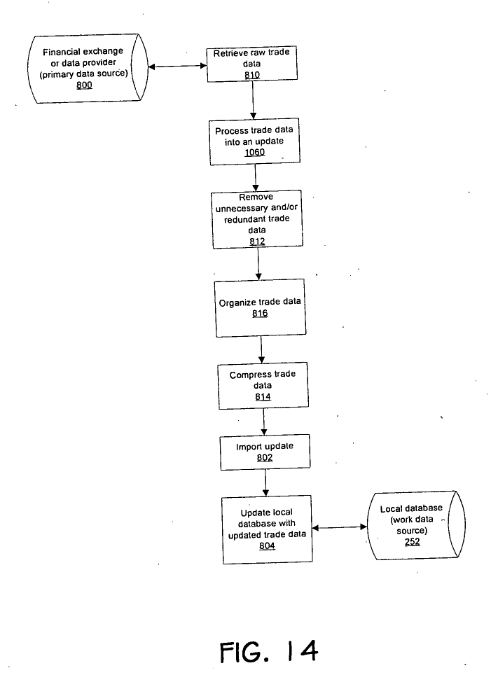

Application 10 may determine various statistical measures for the trade data. Application 10 may calculate the statistical measures as needed, e.g., when creating a displayed table or graph showing a statistical measure. Alternatively, the statistical measures may be determined by the primary 800 (FIG. 14) or an intermediate data source 801 (FIG. 18) and stored with the trade data. A combination of these methods may also be used wherein statistical measures for some financial products 120 (FIG. 1) and time units 342 are stored as trade data in data source 252 (FIG. 2) whereas statistical measures for other time units 342 are calculated as needed by application 10. FIG. 13 lists formulas that may be used to calculate the statistical measures.

The statistical measures may include summary open interest which is the sum of open interests for all strike prices. In addition, summary ITM and OTM open interest may be calculated; summary ITM and OTM open interests are the sums of open interests for all ITM and OTM strike prices, respectively. The dollar weighted open interest may be determined as the sum of all open interests for each strike price multiplied by the underlying option's trade price. ITM and OTM dollar weighed open interests are calculated in the same way but using only ITM or OTM strike prices respectively.

The ITM pain strike price may be determined as the strike price with the highest ITM open interest. The OTM pain strike price may be determined as the strike price with the highest OTM open interest. The ITM pain open interest may be determined as the open interest of the ITM strike price with the highest open interest. The OTM pain OI may be determined as the open interest of the OTM strike price with the highest open interest.

The put to call ratio may be calculated as the sum of open interest for all put options divided by the sum of open interest for all call options. The ITM and OTM put to call ratios may be calculated in the same way but using only ITM and OTM options respectively. The put to call dollar weighted ratio may be calculated the sum of open interest for all put options multiplied by the underlying option trade price divided by the sum of open interest for all call options multiplied by the underlying option trade price. The ITM and OTM put to call dollar weighted ratios may be calculated in the same way but using only ITM and OTM options respectively.

The composite implied volatility measures whether options are relatively expensive or inexpensive and may be calculated using a Black model for futures formula. A modified composite implied volatility may be calculated, wherein the modified implied volatility is determined considering only the ITM option strike price nearest to the ending trade price and the three OTM option strike prices nearest to the ending trade price for each time unit.

Greek statistics may be calculated for trade data. The Greek statistics include but are not limited to delta, gamma, lamda, theta, vega, zeta, and rho. Delta is the amount by which the price of an option contract changes for every dollar move in the underlying financial product. Delta represents the ratio of the change in the theoretical value over the change in the underlying price. Gamma is the amount delta changes when the underlying price changes by one unit. It is the degree by which delta changes with respect to changes in the underlying price. Lamda is the percent change in the option contract price for a percent change in the underlying price. Rho is the change in theoretical value with respect to a change in the interest rate. Theta measures the time decay of a position; i.e., it represents the amount that the theoretical value changes in one day if there is no change in the underlying price. Vega is the amount that the theoretical value changes when the volatility changes by 1%. Zeta is the percentage change in an options price per 1% change in implied volatility.

10. Importing and Refreshing Trade Data

10.1 Data Flow

A process for retrieving trade data from a primary data source and updating a working data source 252 with new or missing trade data is shown in block form in FIG. 14. The updated trade data may be retrieved from a primary data source 800 by application 10 or another application, which may be on a second computer or a server. The updated trade data may comprise trade data from a selected time span. The updated trade data may comprise all new trade data since the last time the primary data source 800 was accessed.

Working data source 252 may be updated with the updated trade data on a periodical schedule which user may determine. Primary data source 800 or another server may push updates to working data source 252, in which case, working data source 252 will process the updated trade data 804 when the updated data becomes available from primary data source 800 and primary data source 800 advertises the updated data to working data source 252.

Alternatively, the user may select to update working data source 252. For example, the user may click a refresh button 806 (FIG. 1) and application 10 may query primary data source 800 (FIG. 18) or an intermediate data source 801 (FIG. 18) for new or updated trade data. Alternatively, application 10 may retrieve trade data from primary data source 800 (FIG. 18) or an intermediate data source 801 (FIG. 18) with out a query. Alternatively, the user may download updated trade data, e.g., from a bulletin board, web server, network server, FTP server, or mail server, and clicking refresh button 806 (FIG. 1) may cause working data source 252 (FIG. 14) to import 802 the new or updated trade data. There may also be one or more intermediate data sources 801 (FIG. 18) between primary data source 800 and working data source 252, in which case, working data source 252 may instead query or import new or updated trade data from intermediate data source 801. Intermediate data source 801 may import new or updated trade from another intermediate data source 801 or primary data source 800.

10.2 Example Primary Data Source and Processing

10.2.1 Liquidity Databank Data File

In one embodiment, primary data source 800 (FIG. 14) is the Chicago Board of Trade. Primary data source 800 produces multiple files of raw daily trade data 810 each day which may comprise 25,000 to 35,000 lines of data or more. The files of raw trade data 810 may comprise a LIQUIDITY DATABANK (LDB) data file, an option prices data file, an end of day prices data file, and an option open interest data file. The LDB volume data file may comprise trade data organized by financial product symbol, price, and contract term. The trade data may comprise trade date and time; contract year; and contract month, volume type, e.g., spread or non-spread. The LDB volume data file may further comprise buy, sell, and net volume for each of one or more trader groups, e.g., CTI1, CTI2, CTI3, and CTI4.

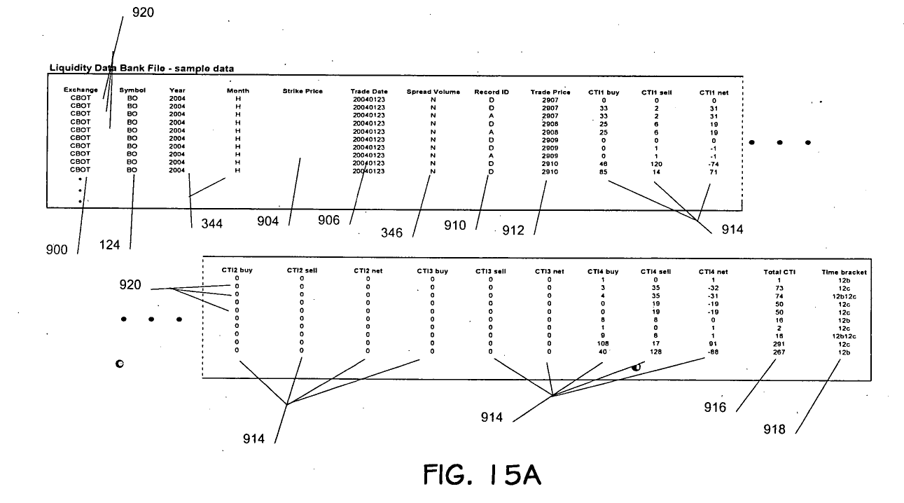

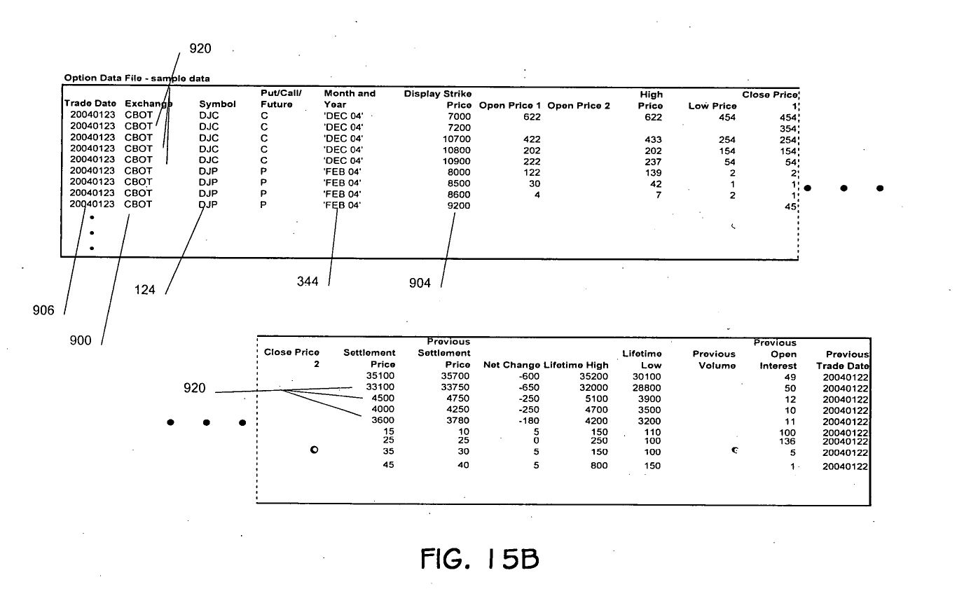

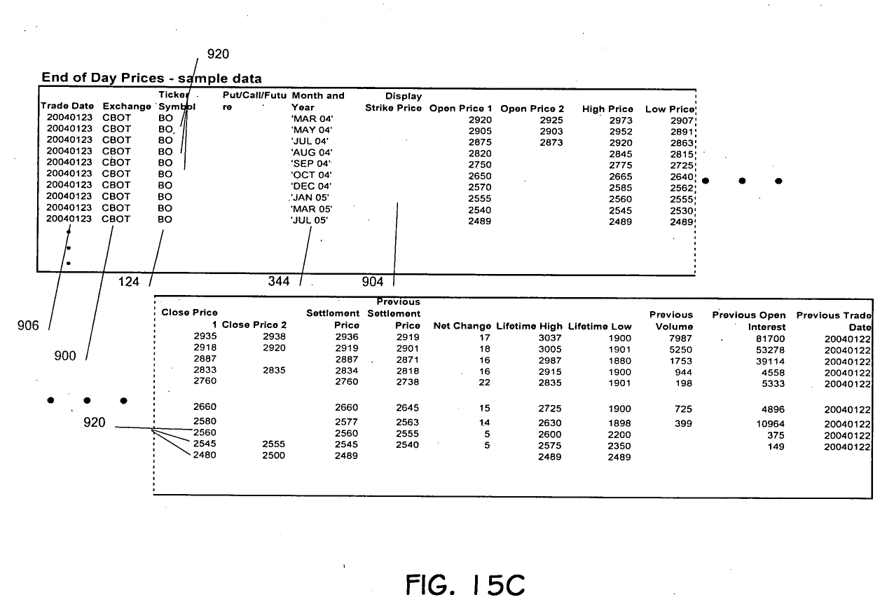

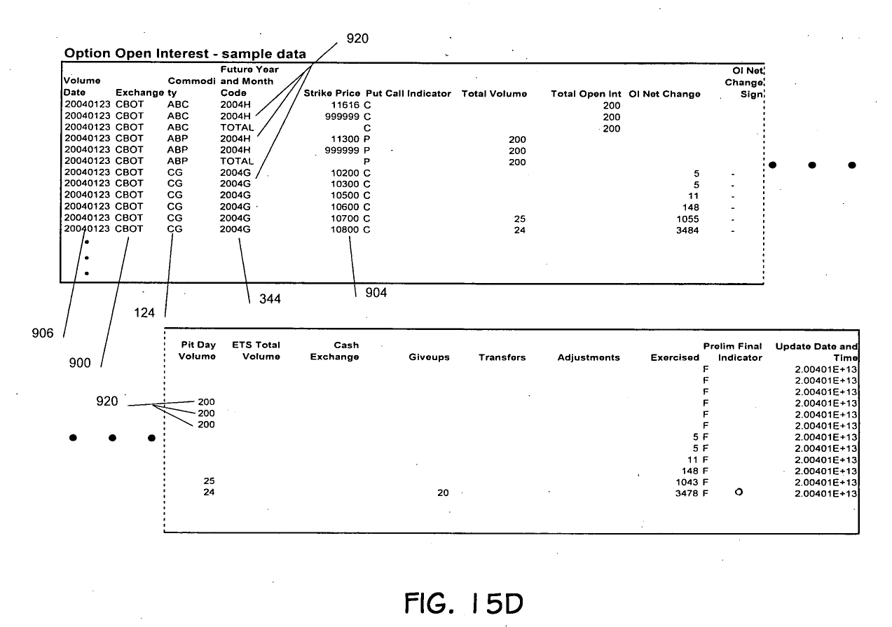

The LDB volume trade data may be processed (step 1060, FIG. 14) by extracting trade data for a financial product comprising trading prices, trading time, and trade volumes for each financial product. As an example, FIG. 15A shows a partial LDB data file containing several trade data entries in separate rows. In the example, columns are provided for financial institution name 900; financial product symbol 124; contract term 344; strike price 904; trade date 906; volume type 346; record type 910; trade price 912; buy, sell, and net volumes for CTI1, CTI2, CTI3, and CTI4 914, total volume 916, and trade time bracket 918. The record id 910 may by ‘D’ or ‘A’ indicating trade data for a time bracket 918 or accumulated for the day. Each row 920 in the LDB data file may give trade data for a discrete combination of trade price 912, volume type 346, and contract term 344. The LDB volume data file may be processed by extracting a sub-set of the traded data.

For example, the LDB data file may have a trade data granularity of 15 minutes, however, working data source 252 (FIG. 14) may have a trade data granularity of 1 day. In this case, the daily accumulated, or ‘A’, records may be extracted and retained while the time bracket, or ‘D’, records may be discarded. Alternatively, the trade data for time brackets may be accumulated and stored as a specific trade data granularity. For example, if the desired trade data granularity is 1 hour and primary data source 800 has a trade data granularity of 15 minutes, then the four 15 minute time brackets in each hour may be accumulated into an hour time unit and retained. In this way, large data files may be processed (step 812, FIG. 14) into much smaller data files before compressing (step 814, FIG. 14).

10.2.2 Option Price Trade Data File

The option price trade data file may comprise trade data organized by financial product symbol 124, trade date 906, strike price 904, and contract term 344, and contract type 930. The option price trade data file (FIG. 15B) may comprise trade date 906; institution 900, symbol 124, put/call/future flag 930, contract term 344, strike price 904, opening prices, high and low prices, close prices, settlement price, previous price, net change, lifetime high, lifetime low, previous volume, previous open, and previous trade date.

The option price trade data file data may be processed (step 1060, FIG. 14) by extracting trade data for a financial product comprising strike prices 904 (FIG. 15B), contract term 344, trading time 906, opening and closing prices, high and low prices, settlement prices, and lifetime high and low prices. Each row 920 in the option price trade data file may represent a discrete combination of strike price 904 and contract term 344 for each financial product.

10.2.3 End of Day Price Trade Data File

The end of day price data file (FIG. 15C) may comprise trade data organized by financial product symbol 124, trade date 906, and contract term 344, institution 900, opening prices, high and low prices, close prices, settlement price, previous price, net change, lifetime high, lifetime low, previous volume, previous open interest, and previous trade date.

The end of day price trade data may be processed (step 1060, FIG. 14) by extracting trade data comprising end of day prices for each financial product symbol 124 (FIG. 15C), trade date 906, and contract term 344. Each row 920 in the option price trade data file may represent a unique combination of trade date 906 and contract term 344 for each financial product.

10.2.4 Option Open Interest Trade Data File

The option open interest trade data file may comprise trade data organized by financial product symbol 124, trade date 906, contract term 344, contract type, strike price 904, total volume, total open interest, open interest net change, pit day volume, ETS total, cash give-ups, transfers, adjustments, exercised, and update date and time.

The option open interest trade data file (FIG. 15D) may be processed (step 1060, FIG. 14) by extracting trade data comprising open interests for each financial product symbol 124 (FIG. 15D), trade date 906, contract term 344, and strike price 904. Each row 920 in the option price trade data file may represent a unique combination of trade date, update time, contract term, and strike price for each financial product symbol.

10.2.5 Organizing Trade Data

Once trade data has been extracted and unnecessary data discarded (step 812, FIG. 14), the trade data may be organized (step 816). The trade data may be organized into a LDB day file, a LDB price file, a LDB time file, and an options day file, an futures price file, and an options open interest file. The trade data may be organized as records in the LDB day file by storing the trade volume for each trader group for each unique combination of trade date, contract term, and volume type. The nearest contract term and next nearest contract term may be determined for each record.

The trade data may be organized as records in the LDB price file by storing the trade price and volumes for each financial product organized by financial product, contract term, volume type, trader group, and time brackets traded. The contract position, i.e., nearest term, next nearest term, etc., may be determined for each record.

The trade data may be organized as records in the LDB time file by storing the trade price and volumes for each financial product organized by 15 minute trade time unit, trade date, contract term, volume type, and trader group. The contract position, i.e., nearest term, next nearest term, etc.; hour traded; and 15 minute time zone may be determined for each record.

The trade data may be organized as records in an options day file by storing for each combination of trade date, financial product symbol, and contract term: closing date, contract year, contract month, contract position, implied volatility, volume, ITM volume, OTM volume, open interest, ITM open interest, OTM open interest, dollar weighted open interest, ITM dollar weighted open interest, OTM dollar weighted open interest, ITM pain strike price, OTM pain strike price, ITM pain open interest, OTM pain open interest, put to call ratio, ITM put to call ratio, OTM put to call ratio, dollar weighted put to call ratio, dollar weighted ITM put to call ratio, dollar weighted OTM put to call ratio, and option expire days.

Trade data may be organized as records in a futures prices data file by storing for each unique combination of trade date, financial product symbol, contract term, and price the trade date, contract term, open price, high price, low price, close 1 price, close 2 price, settlement price, lifetime high price, lifetime low price, volume, and open interest. The contract position, i.e., nearest term, next nearest term, and etc., may be determined for each record.

Trade data may be organized as records in an options open interest file by storing for each unique combination of trade date, contract term, financial product symbol, and strike price the trade date, contract term, option volume, open interest, pit volume, ETS volume, give-ups, transfers, adjustments, contract position, implied volatility, and Greeks. The Greeks may include delta, gamma, theta, rho, and vega. A detailed description of the Greeks and implied volatility is given in the “STATISTICAL CALCULATIONS” section.

10.3 Compressing Update

The organized trade data may be stored in compressed update files by compressing (step 814, FIG. 14) with a compressing algorithm. For example, the update files may be compressed into ZIP files. The compressed files then may be imported (step 802) by an intermediate data source 801 (FIG. 18) or work data source 252. The process described above may be executed on the computer running application 10 or a server. For example, the compressed files may be produced on an intermediate computer running an update application. The user then may download the update files, e.g., form an FTP, web, network, or email server, or receive them via an update service, e.g., an email service or a push or publishing server.

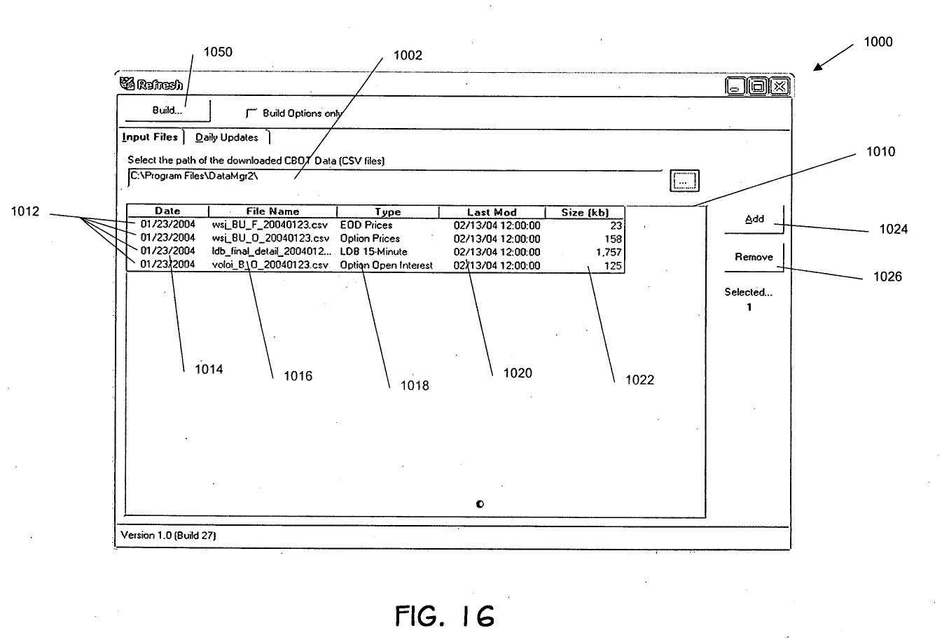

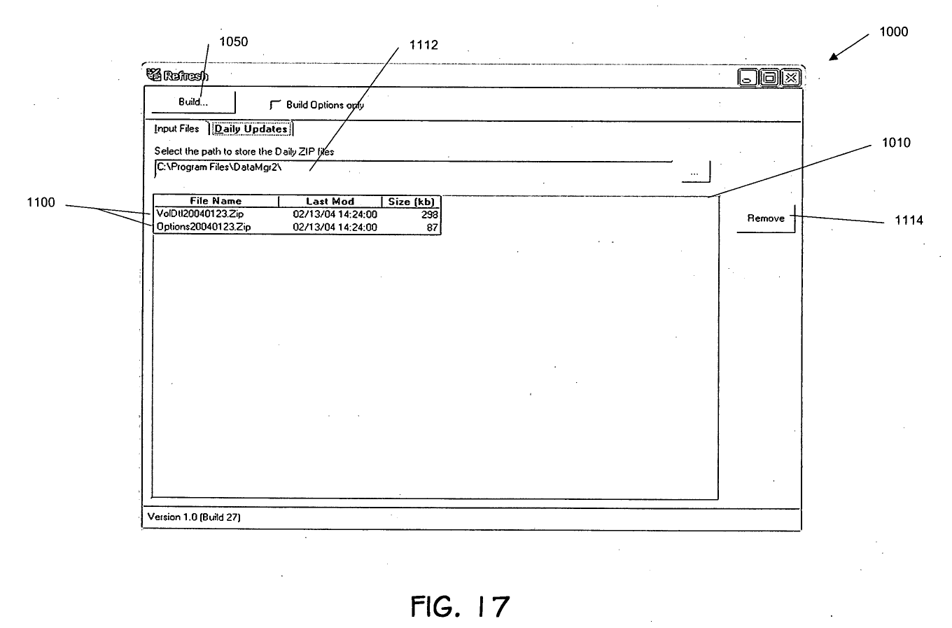

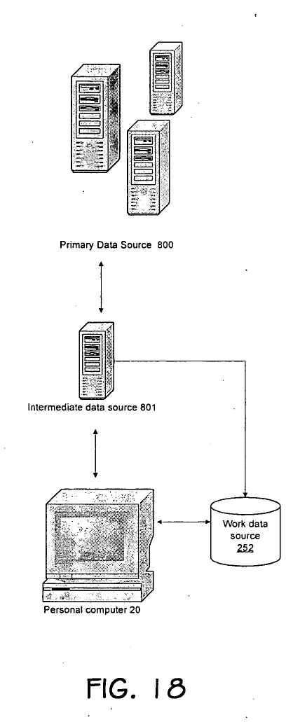

An example application 1000 for processing (step 1060, FIG. 14), removing unnecessary data (step 812), and organizing (step 816) trade data is shown in FIGS. 16 and 17. The user is able to import raw data files from a financial institution into a directory using a file transfer program such as a FTP program. The user may then select the directory containing the raw data files or enter the path to the raw data files in a path box 1002. The imported raw data files may be displayed in an input files panel 1010. The input files panel 1010 may show for each raw data file 1012, trade data date 1014, file name 1016, file type 1018, last modification time 1020, and file size 1022.

The user may click an add button 1024 to add additional files or a remove button 1026 to remove files from input files panel 1010. For example, the user may enter a file name in a path box 1002 and click an add button 1024 to add the file to input files panel 1010. The user may then click on file 1012 in input files panel 1010 and click a remove button 1026 to remove the file from input files panel 1010. The user may select one or more of input files 1012 from input files panel 1010 and click a build button 1050 to build the update files.

Update application 1000 may process the data files 1060 (FIG. 14), remove unnecessary data 812, organize the trade data 816, and compress the trade data 814. The compressed update files 1100 (FIG. 17) are displayed in a daily update panel 1110. The user may select a path at which store the compressed update files with an update file path box 1112. The user may select a file in daily update panel 1110 by clicking on file 1100 and then clicking a remove update file button 1114; update file 1100 then may be deleted.

10.4 Importing Update

The compressed trade data then may imported (step 802. FIG. 14) into work data source 252. For example, the update files may be stored in an update directory accessible to the computer executing application 10. The user may click refresh button 806 (FIG. 1) in application 10 to update work data source 252 (FIG. 14). Work data source 252, e.g., a local database, may be updated (step 804) by adding new trade data from the update file to work data source 252. For example, the update files may be uncompressed and moved to a data path. The uncompressed data files may then be appended to existing data files, e.g., yearly data files which may contain all of the trade data for a year. An index may be created for work data source 252 or an existing index may be updated or appending to reflect the addition of the new data.

11. Flowcharts

11.1 Detailed Flowcharts

This section provides a step-by-step description of the flowcharts shown in FIGS. 2, 4A, 4B, 14, and 20. These flowcharts describe an implementation of the invention as it may be implanted in a computer application.

11.1.1. Selecting and Retrieving Trade Data

Turning to FIG. 2, an application implementing the method may first permit the user to select a financial product (step 100). This may be implemented in financial product selection panel 102 (FIG. 1) as a list of financial products. The user then may create a query for trade data. This may be done by either directly entering a query (step 1200, FIG. 2) or building a query using options such as selecting a time span (step 150), e.g., by using time span panel 152 (FIG. 3), and selecting a time unit size (step 200, FIG. 2), e.g., by using time unit size entry field 204 (FIG. 1). In addition, the user may limit the query according to specific contract terms or groups of contract terms (step 210, FIG. 2), e.g., by using LDB data options panel 160 (FIG. 7) or options contracts option panel 172 (FIG. 8), and limit the query according to spread or non-spread trade data (step 224, FIG. 2), e.g., by using LDB data options panel 160 (FIG. 7) or options contracts option panel 172 (FIG. 8). Application 10 may then retrieve the trade data (step 250, FIG. 2) from data source 252.

The time unit size may have some effect on the data retrieval and processing. If application 10 (FIG. 1) or data source 252 (FIG. 2) determines that trade data granularity is smaller than the selected time unit size (step 210, FIG. 2), it may combine the trade data granularity time units with each time unit (step 1220). Otherwise, if the user selected to combine spread and non-spread volume trade data (step 1230), and the volume trade data is separate, application 10 may combine the spread and non-spread trade data (step 225).

11.1.2 Classifying and Displaying Time Unit Trade Data

The trade data then may be classified into time units (step 300, FIG. 2) by grouping together trade data that occurs within the same time unit. If the user selected to combine contracts (step 1240), e.g., by selecting combine contracts box 226 (FIG. 7), application 10 may combine trade data for contracts (step 1250, FIG. 2) having the same contract term, e.g., the same expiration month, but in different years within the selected time span.

Application 10 then may display the time unit trade data (step 324, FIG. 2). Application 10 may do this in time unit table 328 (FIG. 1) or time unit graph 370 (FIG. 5). For time unit table 328 (FIG. 1), application 10 may select columns (step 1260, FIG. 2) of trade data to display by default or the user may select columns (step 1260), e.g., by using drop-down column group box 358 (FIG. 1). Application 10 then may determine, i.e., retrieve from memory or data source 252, the trade data (step 1280, FIG. 2) and display it (step 1290, FIG. 2) in trade unit table 328 (FIG. 1) classified in the manner shown in FIG. 9. Alternatively, the user may select trade data to be plotted (step 1300, FIG. 2) on time unit graph 370 (FIG. 5), e.g., by using time unit graph data selection box 388. Application 10 then may determine, i.e., retrieve from memory or data source 252, the trade data to be plotted (step 1310, FIG. 2) and plot it versus time units (step 1320) for the selected time span.

11.1.3 Interacting with Time Unit Panel

Turning now to FIG. 4A, the user may select a time unit 342 (FIG. 1) from time unit panel 326 and application 10 may determine a price zone time span. The user may select a price zone time span by clicking on time unit graph 370 (FIG. 5) (step 430a, FIG. 4A) above the time unit 342 (FIG. 5) or by clicking a row 340 (FIG. 1) (step 430b, FIG. 4A) of time unit table 328 (FIG. 1). Application 10 may set the end of the price time zone span to the selected time unit. The user may select a number of historical time units (step 432, FIG. 4A), e.g., by using historical time unit selection box 432 (FIG. 1).

Application 10 may then determine the beginning of the price zone time span (step 1330, FIG. 4A) using an iterative loop (steps 434-440). If the user did not select any historical time units (step 440), application 10 may continue to the identifying trade data step 450. Otherwise, application 10 may set a historical-time-units counter to the number of historical time units and then examine the time unit before the selected time unit (step 434). If trading occurred during this time unit (step 436), which may be determined from data source 252, application 10 may subtract a time unit from the historical-time-units counter (step 438). Application 10 then may check if the historical-time-units counter is now equal to zero (step 440) and, if so, set the start of the price zone time span to the current time unit and continue to step 450 to identify trade data for the price zone time span. If historical-time-units counter is greater than zero, application 10 may continue the loop by examining back one more time unit (step 434) and subtracting one from the historical-time-units counter.

11.1.4 Identifying and Classifying Price Zone Trade Data

After determining the price zone time span, application 10 may identify trade data for the price zone time span (step 450). Application 10 may determine trade data by querying the data source 252 (FIG. 14) or by examining price data already in memory (step 1340, FIG. 4A).

After identifying the trade data (step 450), application 10 may determine the size of each price zone (step 1350). The creation of price zones may depend on a user selection of price zones with discrete prices or price ranges (step 1360). The user may make this selection using price zone table drop-down box 516 (FIG. 1). If the price zones are discrete prices, application 10 may create a price zone for each discrete price (step 1370, FIG. 4A) occurring in the trade data for the price zone time span. If the price zones are price ranges, application 10 may determine the high and low prices of trade data in the price zone time span and divide the range into equally sized, non-overlapping price zones (step 506) depending on the number of price zones selected (step 504) by the user. The user may select the number of price zones using prize zone count entry field 505 (FIG. 5).

Application 10 may classify the trade data into the price zones (step 500, FIG. 4A) by grouping together trade data that have prices within each price zone. Application 10 may combine trade data together that occur within each price zone. If there are historical time units (step 1380), application 10 may combine trade data together for time units in the price zone time span that occur within the same price zones (step 1390).

11.1.5 Displaying Price Zone Trade Data

Application 10 may display the price zone trade data in price zone table 510 (FIG. 5) or price zone graph 520 (FIG. 12). For price zone table 510 (FIG. 5), application 10 may select columns 514 of trade data to display by default or the user may select columns 514, e.g., by using the price zone table display drop-down box 516. Application 10 then may determine the trade data (step 1400, FIG. 4A) and display it (step 550) in trade unit table 510 (FIG. 5). Alternatively, the user may select trade data to be plotted (step 1300, FIG. 4A) on price zone graph 530 (FIG. 12), e.g., by using price zone graph drop-down box 555. Application 10 then may determine the trade data to be plotted (step 1420, FIG. 4A) and plot it versus time units for the price zone time span.

11.1.6 Interaction with Price Zone Panel

Now turning to FIG. 4B, the user may select a price zone (steps 600a-b, FIG. 4B) by clicking on price zone graph 520 (FIG. 12) (step 600a, FIG. 4B) above a price zone 554 (FIG. 12) or by clicking a row 512 (FIG. 1) (step 600b, FIG. 4B) of price zone table 510 (FIG. 1).

If prices versus time units are not plotted in time unit graph 370 (FIG. 5), application 10 may plot prices versus time units (step 1450, FIG. 4B). Application 10 then may draw price line 602 (FIG. 5) (step 1470, FIG. 4B) on time unit graph 370 (FIG. 5). Price line 602 may be parallel to time unit axis 374 and correspond to the range of prices or discrete price in the selected price zone, in reference to time unit graph data axis 386. Price line 602 may have a substantial width, so as to appear as a bar.

11.2 Volume Event Graph

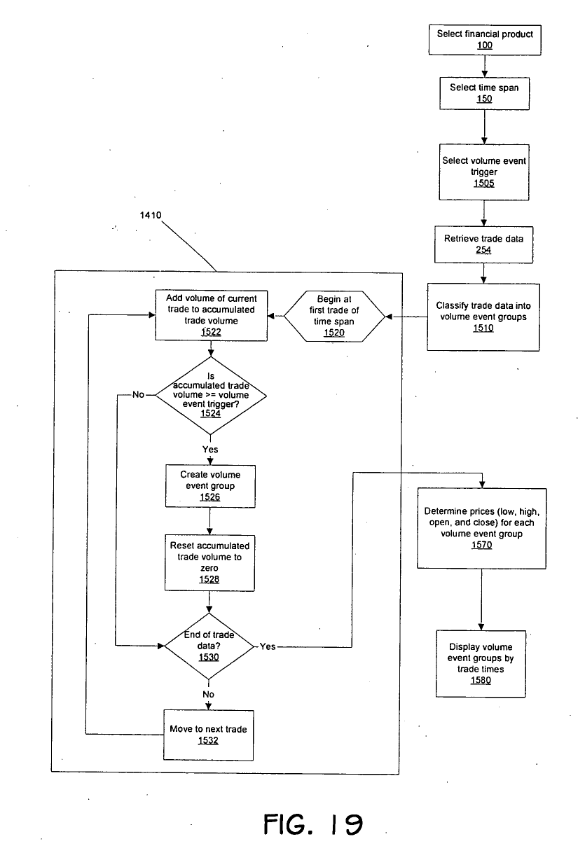

FIG. 19 illustrates one way an application may implement a volume event graph 1500.

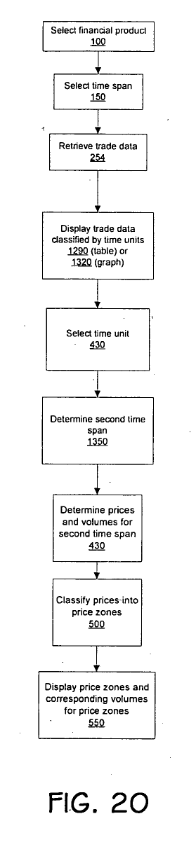

The user may select a financial product (step 100, FIG. 19). This may be implemented in financial product selection panel 102 (FIG. 1) as a list of financial products. The user may select a time span (step 150, FIG. 20), e.g., by using time span panel 152 (FIG. 3). The user may select a volume trigger event (step 1505, FIG. 1). This may be implemented with a volume trigger entry field. Optionally, the user may select a volume type and a trader group. The application then may determine trade data (step 254, FIG. 19). The user may not need to select a time unit size as application 10 may accumulate trade data within the selected time span regardless of trade data granularity.

Once trade data is determined, application 10 may classify the trade data into volume event groups (step 1510, FIG. 19). An example algorithm is given in FIG. 19. Application 10 may begin at the first trade in the time span (step 1520), and add the volume of this trade to an accumulated trade volume register (step 1522). If the accumulated trade volume register is greater than the volume event trigger (step 1524), application 10 may create a volume event group (step 1526) and then reset the accumulated trade volume register (step 1528). If created, the volume event group will have a start time and an end time. Otherwise, application 10 may move to the next step.

Application 10 may check if the end of the trade data, or the selected time span, has been reached (step 1530). If the end of the time span has been reached, application 10 may continue to step 1570 where it may determine prices for each volume event group. Otherwise, application 10 may move to the next trade in the selected time span (step 1532) and return to step 1522 where application 10 adds the current trade volume to the accumulated trade volume register.

Application 10 may determine a low price, high price, opening price, and closing price for each volume event group (step 1570). Application 10 then may display the volume event groups (step 1580). For example, application 10 may create a volume event group graph 1500 (FIG. 21). Volume event graph 1500 may display opening price, closing price, low price, and high price for each volume event group by trade times, e.g., each volume event group 1582 may be an OHLC bar 412 on volume event group graph 1500 (FIG. 21), wherein the position of OHLC bar 412 for each volume event group 1582 with respect to a time axis 1584 (FIG. 21) may correspond to the begin and end times of each volume event group 1582. The begin time or end time of each volume event group may be displayed on volume event group graph 1500. The accumulated volume for each volume event group 1582 may be displayed on volume event group graph 1500. Alternatively, the total accumulated volume for the selected time span though each volume event group 1582 may be displayed on volume event group graph 1500.

11.3 Importing and Refreshing Trade DATA

Now turning to FIG. 14, an intermediate data source 801 (FIG. 18), work data source 252, or an update application, such as update application 1000 (FIG. 6), may import raw trade data from primary data source 800 (FIG. 14), such as a financial institution. Update application 1000 (FIG. 16) may then process the trade data (step 1060, FIG. 14) which may include removing unnecessary trade data (step 812) and organizing the trade data into a more readily accessed form (step 816), e.g., by building a catalog or index. Organizing the data (step 816) may comprise rearranging it from the order produced by primary data source 800. Update application 1000 then may compress the trade data into an update (step 814).

The update may be imported by application 10 (step 802, FIG. 14). This step may comprise downloading an update file. The user may click a refresh button 806 (FIG. 1) in application 10 to import the update file into working data source 252 (step 804, FIG. 14), e.g., a local database. Working data source 252 may be updated with the updated trade data and may build new indexes to allow ready access to the trade data.

11.4 Overview of Method

The flowchart in FIG. 20 provides a simplified overview of the method.

An application implementing the method may first permit the user to select a financial product (step 100, FIG. 20). This may be implemented in the financial product selection panel 102 (FIG. 1) as a list of financial products. The user may select a time span (step 150, FIG. 20), e.g., by using the time span panel 152 (FIG. 3). Application 10 then may determine trade data (step 254, FIG. 20). This may be from data already in memory or from a data source 252. Application 10 then may display trade data classified according to time units. The trade data may be presented as a time unit table 328 (FIG. 1) (step 1290, FIG. 20) or a time unit graph 370 (FIG. 5) (step 1320, FIG. 20).

Once the user is presented with trade data, the user may select a time unit (step 430, FIG. 20), which is a subspan of the time span of trade data displayed. Application 10 then may determine a second time span, which is a price zone time span (step 1330). Application 10 may determine trade data, e.g., volumes and prices, for the price zone time span (step 1430, FIG. 20).

After determining trade data for the price zone time span, the application may classify the trade data into price zones (step 500, FIG. 20). Application 10 then may display the trade data classified into price zones (step 550, FIG. 20), e.g., in a price zone table 510 (FIG. 5) or graph 520 (FIG. 12).

In addition to the steps outlined above, application 10 may permit the user to select a price zone (step 600a and 600b, FIG. 4B), e.g., from a price zone table 510 (FIG. 5) or graph 520 (FIG. 12). Application 10 then may identify a subset of the trade data classified according to time unit having prices within the selected price zone, e.g., by drawing price lines 602 (FIG. 5) (step 1470, FIG. 4B) on time unit graph 370 (FIG. 5).

### 12. EXAMPLES OF USE

### 12.1 Example 1

The method describe in the above written description may be used to gain insight into financial market movement and reactions to internal market and external events.

In one example, a user, or trader, may be a member trader at the Chicago Board of Trade, belonging to the CTI1 trader group, and may want to prepare for trading during the week of Feb. 9^{th}-14^{th, 2004} on Feb. 6^{th, 2004}. The trader may be interested in 10-year notes future contracts.

The trader may know that on Feb. 7^{th} and 8^{th,} 2004, G7 will meet in Boca Raton, Fla., to discuss the U.S. dollar weakness and any policy change may have significant volatility implications for U.S. stocks and bonds. The trader also may know that the U.S. treasury will auction $24 billion in 3-year notes on February 10^{th}, $16 billion in 5-year notes on February 11^{th}, and $16 billion in 10^{th}-year notes on Feb. 12^{th, 2004.}

The trader may want to know the net exposure of the CTI4 trader group, other, non-member traders. The trader may believe that the CTI4 trader group's net position has a very high positive correlation to price movement.

The trader may select 10 year bonds as a financial product, a time unit size of 1 day, and trade data for February 6^{th} in the time unit table. The trader may look at trader group volumes by a single prices zone in the price zone table for 7 days back, in order to correspond with January 28^{th}, the date of Federal Reserve Chairman Allen Greenspan's Humphrey Hawkins testimony in Washington, D.C.

The trader may observe that CTI4 has a very small net short exposure going into the weekend. This may indicate to the trader that there is very little pre-auction hedging in preparation for the $56 billion note auction.

The trader then may look at the price zone table with 4 price zones. The trader may see that the middle zones, $113 to $113.46875 and $113.48438 to $113.95313, comprise 70% of the volume and netted very little exposure. The trader may observer that CTI2 group's position is the mirror image of the CTI4 trader group.

These observations may lead the trader to expect market activity prior to the auction to trade in the $113 to $113.95313 range. Further, if the supply is met with good demand, the trader may expect that the re-pricing of the market will be meet with little resistance since the trader did not observer significant hedges in place.

### 12.2 Example 2

In another example, the user may select a financial product, e.g., soybean futures, for the past 3 months. The user may plot the price versus time units in the time unit graph 370 (FIG. 5). In the price zone table 510, the user may find that the highest trade volume corresponds to a price zone 554 have a range of $797 to $800. The user may click this price zone 554 and draw a price line 602 on the time unit graph 370 which may highlight trade data corresponding to $797 to $800. The user may find that the price has been oscillating up and down and “bumping” the bottom of the price line 602. Thus, the user may decide that the price for the financial product is hitting an area of resistance between $797 and $800.

13. Remarks

The figures and written description illustrate a process, method, and form by which a computer application may implement the invention. However, the execution order of the steps may be changed, and the method of user interaction and display of trade data may be changed. Also, steps may be removed, added, or replaced by default actions implemented in the application or data source. Similarly, the displays illustrated in the figures and described herein may be modified, e.g., for reasons of usability or ascetics.

So, while the foregoing written description of the invention enables one of ordinary skill to make and use what is considered presently to be the best mode thereof, those of ordinary skill will understand and appreciate the existence of variations, combinations and equivalents of the specific exemplary embodiments and methods herein. The invention should therefore not be limited by the above described embodiments and methods, but by all embodiments and methods within the scope and spirit of the invention as claimed.

1. A method for analyzing trade data for financial products comprising the following steps:
selecting at least one financial product from a plurality of financial products,
selecting a first time span, wherein said first time span includes a plurality of time units;
determining trade data for said first time span for said at least one financial product;
displaying said trade data according to said plurality of time units;
selecting at least one of said plurality of time units;
determining a second time span, wherein said second time span includes at least said selected at least one time unit;
determining prices and volumes for said at least one financial product for said second time span;
classifying said prices according to a plurality of price zones;
displaying said plurality of price zones and corresponding volumes for said plurality of price zones.

2. The method of claim 1, wherein each one of said plurality of price zones is a discrete price.

3. The method of claim 1, wherein said financial product is a future contract.

4. The method of claim 1, wherein said financial product is an option contract.

5. The method of claim 1, further comprising:
selecting at least one price zone from said plurality of price zones;
displaying a graph of prices versus time;
drawing a price line corresponding to said selected at least one price zone.

6. The method of claim 1, wherein displaying corresponding volumes said plurality of price zones, further comprises:
determining and displaying for each one of said plurality of price zones a corresponding volume over said second time span.

7. The method of claim 1, wherein determining said second time span, comprises the steps:
selecting a count of time units, wherein said second time span includes said selected at least one of said plurality of time units and said count of time units occurring before said selected at least one of said plurality of time units.

8. The method of claim 1, wherein displaying said trade data further comprises:
displaying for each one of said plurality of time units at least one volume corresponding to at least one of a plurality of trader groups.

9. The method of claim 1, wherein displaying said plurality of price zones further comprises:
displaying for each one of said plurality of price zones at least one volume corresponding to at least one of a plurality of trader groups.

10. The method of claim 1, wherein displaying said trade data further comprises:
determining and displaying for each one of said plurality of time units a composite implied volatility.

11. The method of claim 1, wherein displaying said plurality of price zones further comprises:
determining and displaying for each one of said plurality of price zones a modified composite implied volatility.

12. The method of claim 1, wherein displaying said plurality of price zones further comprises:
determining and displaying for a subset said plurality of price zones an in-the-money pain strike price, wherein said subset of said plurality of price zones correspond to prices which are in-the-money.

13. The method of claim 1, wherein displaying said plurality of price zones further comprises:
determining and displaying for a subset said plurality of price zones an out-of-the-money pain strike price, wherein said subset of said plurality of price zones correspond to prices which are out-of-the-money.

14. The method of claim 1, wherein displaying said plurality of price zones further comprises:
determining and displaying for a subset of said plurality of price zones an in-the-money pain open interest, wherein said subset of said plurality of price zones correspond to prices have prices which are in-the-money.

15. The method of claim 1, wherein displaying said plurality of price zones further comprises:
determining and displaying for a subset of said plurality of price zones an out-of-the-money pain open interest, wherein said subset of said plurality of price zones correspond to prices have prices which are out-of-the-money.

16. A method for analyzing trade data for financial products comprising the following steps:
selecting at least one financial product from a plurality of financial products;
selecting a first time span;
selecting a time unit size;
dividing said first time span into a plurality of time units;
determining first trade data for said at least one financial product, wherein said first trade data comprises contract prices;
classifying said first trade data into said plurality of time units;
selecting a subspan of said first time span;
determining a second time span, wherein said second time span includes at least said selected subspan;
determining second trade data for said at least one financial product for said second time span, wherein said second trade data comprises contract prices;
classifying said second trade data according to a plurality of price zones;
selecting at least one price zone of said plurality of price zones;
identifying a subset of said first trade data having contract prices within said selected price zone.

17. A method for analyzing trade data for financial products comprising the following steps:
selecting at least one financial product from a plurality of financial products;
selecting a time span;
selecting a volume event trigger;
determining trade data comprising contract prices and volumes and trade times for said at least one financial product;
classifying said trade data according to a plurality of volume event groups, wherein each one of said plurality of volume event groups comprises trade data having an accumulated volume corresponding to said volume event trigger;
determining a low price, high price, open price, and close price for each volume event group.

18. The method of claim 17 further comprising the steps:
displaying a graph of said plurality of volume event groups by trade times.

19. A method for organizing trade data for financial product contracts into a data source, comprising the following steps:
processing data comprising volumes, prices, strike prices, option open interests, contract terms, and trade dates;
classifying said volumes according to said prices and said trade dates;
classifying said strike prices according to said contract terms and said trade dates;
classifying said option open interests according to said contract terms, said trade dates, and said strike prices.

20. The method of claim 19 wherein said step of processing data further comprises processing end of day prices and wherein said method further comprises classifying said end of day prices according to said contract terms and said trade dates.
